(19) United States
(12) Patent Application Publication
(10) Pub. No.: US 2009/0252018 A1
(43) Pub. Date: Oct. 8, 2009

(54) HOLOGRAM LENS MANUFACTURING APPARATUS, HOLOGRAM LENS, METHOD OF MANUFACTURING HOLOGRAM LENS, INFORMATION RECORDING APPARATUS, AND INFORMATION REPRODUCING APPARATUS

(75) Inventors: Norihiro Tanabe, Kanagawa (JP); Hisayuki Yamatsu, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/416,366

(22) Filed: Apr. 1, 2009

(30) Foreign Application Priority Data
Apr. 4, 2008 (JP) 2008-098495

(51) Int. Cl. G11B 7/00; G03H 1/04; G03H 1/28; G02B 5/32

(52) U.S. Cl. 369/112.15; 359/1; 359/24; 359/20; G9B/7

(57) ABSTRACT

A hologram lens manufacturing apparatus includes: a separation unit that separates a light beam emitted from a light source into a reference light beam and an irradiation light beam; an irradiation light irradiating unit that collects the irradiation light beam so as to have a focal point at a predetermined focal position, and irradiates a hologram recording element located on the way to the focal point with the irradiation light beam; and a reference light irradiating unit that irradiates the hologram recording element with the reference light beam under a predetermined irradiation condition to record an interference pattern occurring between the irradiation light beam and the reference light beam as a hologram.

### CROSS REFERENCES TO RELATED APPLICATIONS

The present invention contains subject matter related to Japanese Patent Application JP2008-098495 filed in the Japanese Patent Office on Apr. 4, 2008, the entire contents of which being incorporated herein by reference.

### BACKGROUND OF THE INVENTION

1. Field of the Invention

The present invention relates to a hologram lens manufacturing apparatus, a hologram lens, a method of manufacturing a hologram lens, an information recording apparatus, and an information reproducing apparatus, and is suitably applied, for example, to an optical information recording medium on which information is recorded by using a light beam and from which the information is reproduced by using the light beam.

2. Description of the Related Art

Optical information recording media of disc shape, or optical discs, have been widely prevalent heretofore. Compact discs (CDs), digital versatile discs (DVDs), and Blu-ray Discs (Registered trademark) (hereinafter, referred to as BDs) are commonly used.

Optical disc apparatuses compatible with such optical discs record various information on the optical discs, including various types of contents such as music contents and video contents and various types of computer data. In recent years, videos have gotten higher in resolution and music higher in quality with increased amounts of information, and the number of contents desired to be recorded on a single optical disc has been on the increase. A further enhancement has thus been required of the recording capacities of the optical discs.

Some optical discs such as DVDs and BDs have a plurality of signal recording layers for the sake of increased capacity (hereinafter, these discs will be referred to as multilayer discs).

As shown in FIG. 1A, some optical disc apparatuses compatible with such a multilayer disc move their objective lens OL depending on the signal recording layer Y (Y0 or Y1) to form recording marks on (hereinafter, referred to as target recording layer) so as to change the distance DS from the objective lens OL to the surface (hereinafter, referred to as disc surface) 100a of the multilayer disc 100. The optical disc apparatuses can thus displace the focal point of the light beam in the direction of the optical axis of the light beam, thereby adjusting the focal point of the light beam to the target recording layer so that recording marks can be formed on the target recording layer.

As a technique for increasing the recording capacity of an optical disc, there has been proposed an optical disc apparatus which separates a light beam emitted from a single light source into first and second light beams, and makes them overlap each other inside an optical disc 200 as shown in FIG. 1B so that the first and second light beams interfere with each other to form a minute hologram as a stereoscopic recording mark.

This optical disc apparatus moves the objective lenses OL1 and OL2 according to the position in the thickness direction (hereinafter, referred to as target depth) where to form the recording mark, thereby changing the distance DSa between the objective lens OL1 and a first surface 200A of the optical disc 200 and the distance DSb between the objective lens OL2 and a second surface 200B of the optical disc 200.

In consequence, the optical disc apparatus changes the focal positions of both the first and second light beams so that a plurality of recording marks are formed and stacked in the thickness direction of the optical disc, thereby recording information as much as a plurality of layers into the single, thick stereoscopic mark recording layer 201 (refer to e.g., Jpn. Pat. Appln. Laid-Open Publication No. 2007-220206 [FIGS. 1, 4, and 5]).

### SUMMARY OF THE INVENTION

Now, in order to collect a light beam (i.e., convert it into convergent light) and irradiate an optical disc with it, a so-called lens that is made of a material having a diffractive index different from that of air and collects the light beam to a single point according to its shape like an objective lens is typically used. Lenses have various limitations, however, because the spherical aberration, focal length, and the like are uniquely determined by their shape.

The present invention has been achieved in view of the foregoing, and is to propose a hologram lens which can produce a light beam of convergent light, a hologram lens manufacturing apparatus and manufacturing method for fabricating such a hologram lens, and an information recording apparatus and information reproducing apparatus which use such a hologram lens.

To solve the foregoing problem, a hologram lens manufacturing apparatus according to an aspect of the present invention includes: a separation unit that separates a light beam emitted from a light source into a reference light beam and an irradiation light beam; an irradiation light irradiating unit that collects the irradiation light beam so as to have a focal point at a predetermined focal position, and irradiates a hologram recording element located on the way to the focal point with the irradiation light beam; and a reference light irradiating unit that irradiates the hologram recording element with the reference light beam under a predetermined irradiation condition to record an interference pattern occurring between the irradiation light beam and the reference light beam as a hologram.

Consequently, a light beam having the same properties as those of the irradiation light beam of convergent light can be produced by irradiating the hologram recording element having the hologram recorded thereon, or hologram lens, with a light beam having the same properties as those of the reference light beam.

A hologram lens according to an aspect of the present invention includes a single hologram recorded by irradiation with a single irradiation light beam of convergent light focusing on a single focal position and a single reference light beam projected under a single irradiation condition.

Consequently, a light beam having the same properties as those of the irradiation light beam of convergent light can be produced by irradiating the hologram lens with a light beam having the same properties as those of the reference light beam.

A method of manufacturing a hologram lens according to an aspect of the present invention includes a single hologram recording step of collecting an irradiation light beam so as to have a focal point at a single focal position, irradiating a hologram recording element located on the way to the focal position with the irradiation light beam, and irradiating the hologram recording element with a reference light beam under a single irradiation condition to record a single hologram, the reference light beam and the irradiation light beam being emitted from a single light source before separation.

Consequently, a light beam having the same properties as those of the irradiation light beam of convergent light can be produced by irradiating the hologram recording element having the hologram recorded thereon, or hologram lens, with a light beam having the same properties as those of the reference light beam.

An information recording apparatus according to an aspect of the present invention includes: a hologram lens that is opposed to an optical information recording medium and has a hologram recorded by irradiation with an irradiation light beam of convergent light having a focal point at a predetermined focal position and a reference light beam projected under a predetermined irradiation condition; a light source that emits a light beam having the same wavelength as that of the reference light beam; and an irradiating unit that irradiates the hologram lens with the light beam under the predetermined irradiation condition to make the hologram lens produce a diffracted light beam having a focal point at the focal position and irradiates the optical information recording medium with the diffracted light beam.

Consequently, a light beam having the same properties as those of the irradiation light beam of convergent light can be produced by irradiating the hologram lens, which is a hologram recording element having a hologram recorded thereon, with a light beam having the same properties as those of the reference light beam.

An information reproducing apparatus according to an aspect of the present invention includes: a hologram lens that is opposed to an optical information recording medium and has a hologram recorded by irradiation with an irradiation light beam of convergent light having a focal point at a predetermined focal position and a reference light beam projected under a predetermined irradiation condition; a light source that emits a light beam having the same wavelength as that of the reference light beam; an irradiating unit that irradiates the hologram lens with the light beam under the predetermined irradiation condition to make the hologram lens produce a diffracted light beam having a focal point at the focal position and irradiates the optical information recording medium with the diffracted light beam; and a light detection unit that detects the presence or absence of light modulation on the diffracted light beam corresponding to the presence or absence of a recording mark near the focal point of the diffracted light beam.

Consequently, a light beam having the same properties as those of the irradiation light beam of convergent light can be produced by irradiating the hologram lens, which is a hologram recording element having a hologram recorded thereon, with a light beam having the same properties as those of the reference light beam.

According to the present invention, it is possible to produce a light beam having the same properties as those of the irradiation light beam of convergent light by irradiating the hologram lens, which is a hologram recording element having a hologram recorded thereon, with a light beam having the same properties as those of the reference light beam. This consequently makes it possible to achieve a hologram lens which can produce a light beam of convergent light, a hologram lens manufacturing apparatus and manufacturing method for manufacturing such a hologram lens, and an information recording apparatus and information reproducing apparatus which use such a hologram lens.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIGS. 1A and 1B are schematic diagrams for explaining the formation of a conventional recording mark;

FIGS. 2A and 2B are schematic diagrams for explaining the properties of a hologram;

FIGS. 3A and 3B are schematic diagrams for explaining the principle (1) of a hologram lens;

FIGS. 4A and 4B are schematic diagrams for explaining the principle (2) of the hologram lens;

FIG. 5 is a schematic diagram showing the configuration of a hologram lens manufacturing apparatus according to a first embodiment of the present invention;

FIGS. 6A and 6B are schematic diagrams for explaining angle multiplex recording (1);

FIGS. 7A and 7B are schematic diagrams for explaining angle multiplex recording (2);

FIG. 8 is a schematic diagram showing the configuration of an optical disc apparatus according to the first embodiment;

FIG. 9 is a schematic diagram showing the configuration (1) of an optical pickup according to the first embodiment;

FIGS. 10A and 10B are schematic diagrams for explaining the angle of a rotating mirror and a focal point;

FIG. 11 is a schematic diagram showing the configuration of a hologram lens manufacturing apparatus according to another embodiment;

FIG. 12 is a schematic diagram showing the configuration of an optical pickup according to another embodiment;

FIGS. 13A and 13B are schematic diagrams for explaining the formation (1) of a recording mark according to a second embodiment of the present invention;

FIGS. 14A and 14B are schematic diagrams showing the configuration of an optical disc according to the second embodiment;

FIG. 15 is a schematic diagram for explaining the formation (2) of a recording mark according to the second embodiment;

FIG. 16 is a schematic diagram showing the configuration of a hologram lens manufacturing apparatus according to the second embodiment;

FIG. 17 is a schematic diagram showing the appearance and configuration of an optical pickup according to the second embodiment;

FIG. 18 is a schematic diagram showing the configuration of the optical pickup according to the second embodiment;

FIG. 19 is a schematic diagram for explaining the irradiation of a servo light beam according to the second embodiment;

FIG. 20 is a schematic diagram showing the configuration (1) of detection areas of a photodetector;

FIG. 21 is a schematic diagram for explaining the irradiation of a recording light beam according to the second embodiment;

FIG. 22 is a schematic diagram for explaining the irradiation of a diffracted light beam according to the second embodiment;

FIG. 23 is a schematic diagram for explaining the irradiation of a reproducing light beam according to the second embodiment;

FIG. 24 is a schematic diagram for explaining thinning of a second surface optical system;

FIGS. 25A and 25B are schematic diagrams for explaining the recording of a hologram according to a third embodiment of the present invention;

FIG. 26 is a schematic diagram for explaining the principle of formation of a recording mark according to the third embodiment;

FIG. 27 is a schematic diagram showing the configuration of a hologram lens manufacturing apparatus according to the third embodiment;

FIGS. 28A and 28B are schematic diagrams for explaining the manufacturing of a hologram lens according to the third embodiment;

FIG. 29 is a schematic diagram showing the configuration of an optical pickup according to the third embodiment;

FIG. 30 is a schematic diagram for explaining the irradiation of a servo light beam according to the third embodiment;

FIG. 31 is a schematic diagram for explaining information recording processing according to the third embodiment;

FIG. 32 is a schematic diagram for explaining the irradiation of a recording light beam according to the third embodiment;

FIG. 33 is a schematic diagram for explaining the irradiation of a diffracted light beam according to the third embodiment;

FIGS. 34A and 34B are schematic diagrams for explaining the production of the diffracted light beam according to the third embodiment;

FIG. 35 is a schematic diagram for explaining the irradiation of a reproducing light beam according to the third embodiment; and

FIG. 36 is a schematic diagram showing the configuration (2) of an optical pickup according to another embodiment.

### DETAILED DESCRIPTION OF THE PREFERRED EMBODIMENTS

Hereinafter, an embodiment of the present invention will be described in detail with reference to the drawings.

### (1) First Embodiment

### (1-1) Manufacture of Hologram Lens

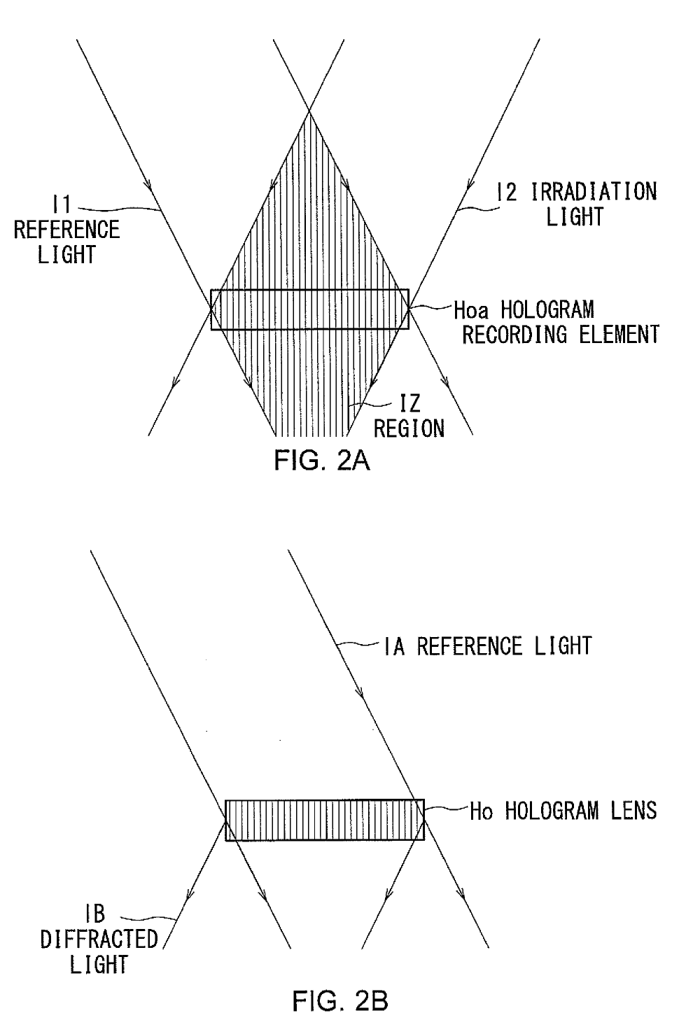

Description will initially be given of the general principle of a hologram. As shown in FIG. 2A, a hologram element Ho can be created, for example, by recording an interference pattern that occurs when reference light 11 and irradiation light 12 overlap each other, onto a hologram recording element Hoa.

As shown in FIG. 2B, when this hologram element Ho is irradiated with reference light 1A that has the same properties as those of the reference light 11, a diffracted light beam 1B having the same properties as those of the irradiation light 12 can be produced by diffraction in the hologram element Ho.

That is, an interference pattern created by the irradiation of two light beams is recorded on the hologram element Ho as a hologram. When this hologram element Ho is irradiated with one of the light beams, it can reproduce the other light beam.

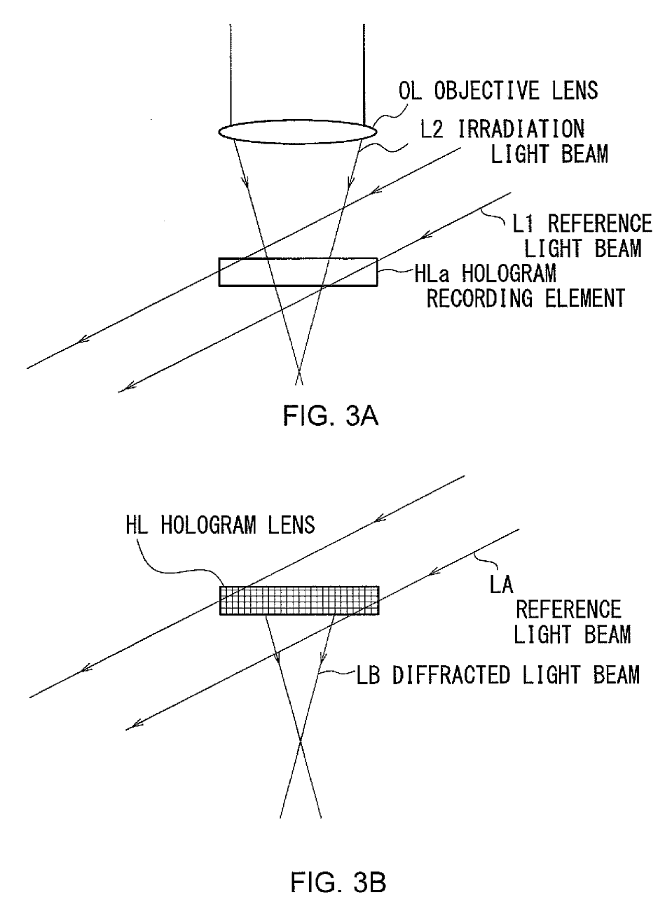

According to the first embodiment of the present invention, this principle is applied to manufacture a hologram lens HL. More specifically, as shown in FIG. 3A, a reference light beam L1 of, e.g., parallel light is overlapped with an irradiation light beam L2 of convergent light which is collected by an objective lens OL. According to the first embodiment of the present invention, the reference light beam L1 and the irradiation light beam L2 interfere with each other to create an interference pattern, and this interference pattern is recorded on a hologram recording element HLa as a hologram, thereby manufacturing the hologram lens HL.

Consequently, as shown in FIG. 3B, when the hologram lens HL is irradiated with a reference light beam LA having the same properties as those of the reference light beam L1, the hologram lens HL can produce a diffracted light beam LB having the same properties as those of the irradiation light beam L2 which is collected by the objective lens OL. That is, the hologram lens HL can produce the diffracted light beam LB of convergent light in response to the reference light beam LA.

According to the first embodiment of the present invention, the hologram lens HL is opposed to an optical disc and irradiated with the reference light beam LA, whereby this hologram lens HL is used as a substitute for what is called an objective lens that collects a light beam and irradiates an optical disc 100 with it.

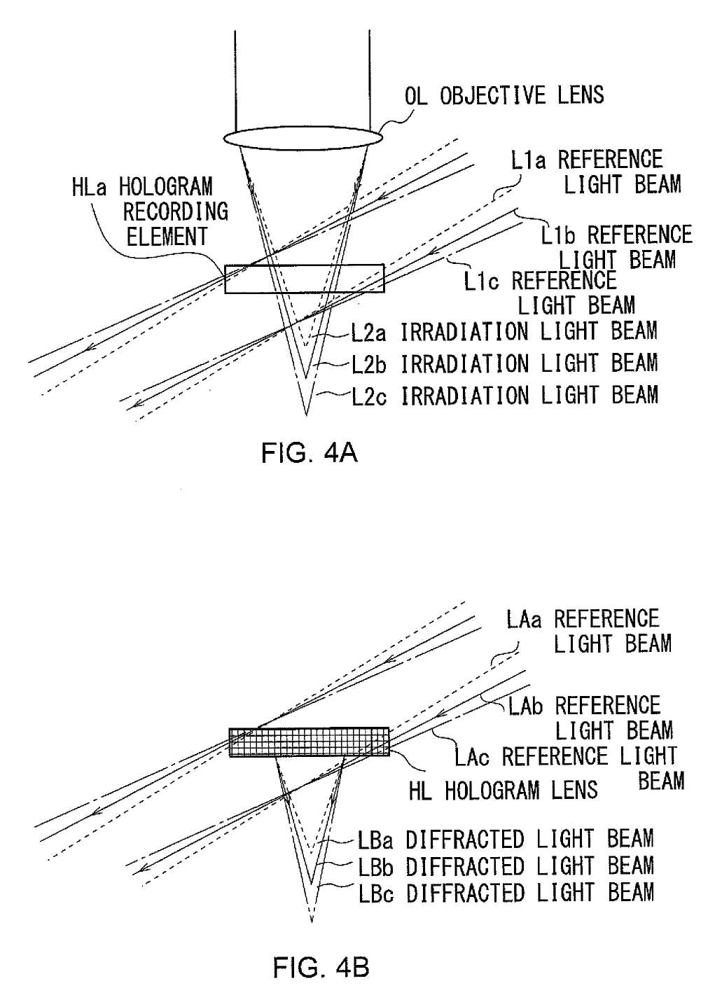

According to the first embodiment of the present invention, as shown in FIG. 4A, reference light beams L1 (L1a to L1c) having different angles of incidence, or irradiation conditions, with respect to the hologram recording element HLa and irradiation light beams L2 (L2a to L2c) having different focal lengths with different focal positions are respectively combined in pairs for irradiation.

That is, according to the first embodiment of the present invention, not just one hologram is formed by a pair of reference light beam L1 and irradiation light beam L2. Another hologram is formed by another pair of reference light beam L1 and irradiation light beam L2, including a reference light beam L1 having a different angle of incidence and an irradiation light beam L2 having a different focal position, and the rest in the same way.

Consequently, according to the first embodiment of the present invention, a plurality of holograms resulting from a plurality of pairs of reference light beams L1 and irradiation light beams L2 are recorded on one hologram recording element HLa in a multiple fashion.

Consequently, as shown in FIG. 4B, the hologram lens HL can produce diffracted light beams LB (LBa to LBc) that focus on respective different positions, according to the angles of incidence of the reference light beams LA (LAa to LAc) incident thereon.

That is, the hologram lens HL can change the focal length of the diffracted light beam LB depending on the angle of incidence of the reference light beam LA. The hologram lens HL can thus adjust the focal point of the diffracted light beam LB, for example, to a signal recording layer Y (hereinafter, referred to as target recording layer) to be irradiated with a light beam in an optical disc that has a plurality of signal recording layers Y (hereinafter, this disc will be referred to as multilayer disc).

It is generally known that when the interior of a multilayer disc 100 is irradiated with a light beam, a spherical aberration occurs as much as corresponding to the position from the surface of the optical disc 100 (hereinafter, referred to as disc surface 100a) to the focal point of the light beam (hereinafter, this position will be referred to as in-disc depth).

According to the first embodiment of the present invention, a spherical aberration to occur is assumed according to the in-disc depth of irradiation of the diffracted light beam LB when the multilayer disc 100 is irradiated with this diffracted light beam LB. The hologram recording element HLa is then irradiated with an irradiation light beam L2 to which a spherical aberration having an opposite sign to that of the assumed spherical aberration is added in advance.

Consequently, the hologram lens HL can produce a diffracted light beam LB that has the spherical aberration of opposite sign to that of the spherical aberration to occur according to the in-disc depth, so that the spherical aberration of the diffracted light beam LB occurring in the multilayer disc 100 can be compensated by the spherical aberration of opposite sign. As a result, the hologram lens HL can make the spherical aberration of the diffracted light beam LB near zero at the focal point FB of the diffracted light beam LB with which the multilayer disc 100 is irradiated.

### (1-2) Configuration of Hologram Lens Manufacturing Apparatus

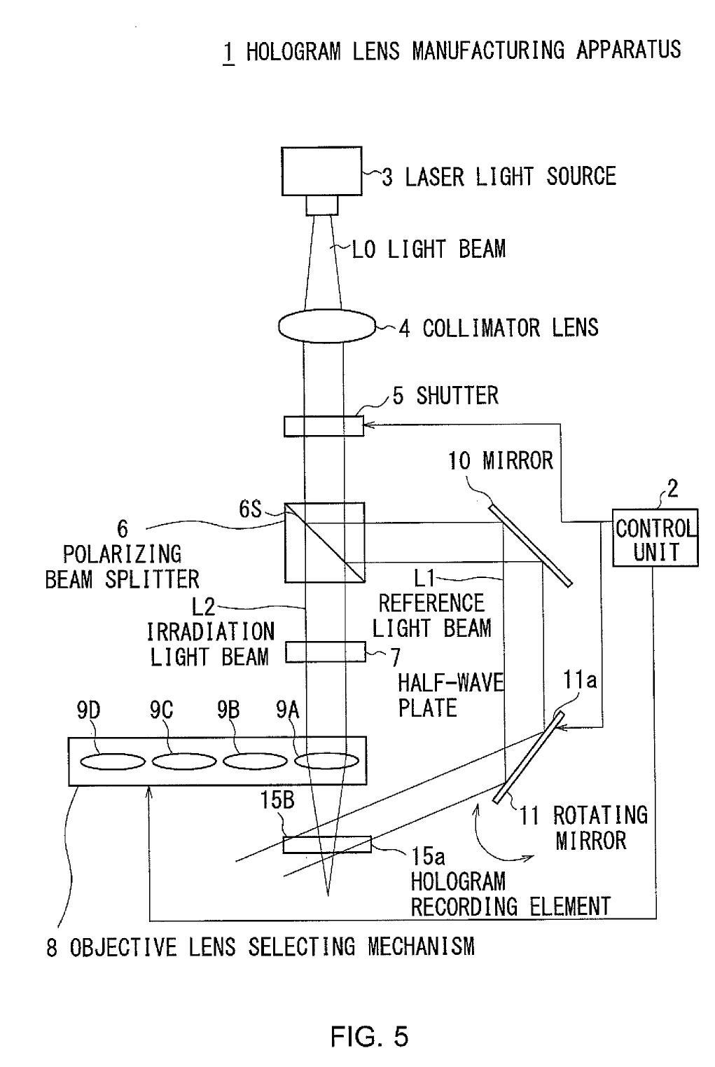

FIG. 5 shows a hologram lens manufacturing apparatus 1 as a whole. The hologram lens manufacturing apparatus 1 includes a control unit 2 which exercises centralized control on the entire apparatus. For example, the hologram lens manufacturing apparatus 1 manufactures a hologram lens 15 to be used in an optical disc apparatus that is compatible with a multilayer disc 100 having four signal recording layers Y0, Y1, Y2, and Y3.

The control unit 2 is composed mainly of a not-shown central processing unit (CPU). The control unit 2 reads hologram lens manufacturing programs from a not-shown read only memory (ROM), loads these programs into a not-shown random access memory (RAM), and thereby executes hologram lens manufacturing processing.

A laser light source 3 is composed of a gas laser, solid state laser, or the like, for example, and emits laser light of relatively long coherence length as a light beam L0. The laser light source 3 emits the light beam L0 of 405 nm in wavelength in response to a drive voltage supplied from the control unit 2, and makes the light beam L0 incident on a collimator lens 4.

The collimator lens 4 converts the light beam L0 of divergent light into parallel light and makes it incident on a shutter 5. The shutter 5 transmits or blocks the light beam L0 under the control of the control unit 2.

When a not-shown main power supply of the hologram lens manufacturing apparatus 1 is turned ON, the laser light source 3 emits the light beam L0 and the shutter 5 blocks the light beam L0. When a request to start the hologram lens manufacturing processing is made from a not-shown operation unit, the control unit 2 makes the shutter 5 transmit the light beam L0 so that the light beam L0 is incident on a polarizing beam splitter 6.

The polarizing beam splitter 6 reflects or transmits a light beam at/through its reflecting/transmitting surface 6S in different ratios depending on the direction of polarization of the light beam. This reflecting/transmitting surface 6S transmits almost all of a P-polarized light beam and reflects almost all of an S-polarized light beam.

The polarizing beam splitter 6 transmits a P-polarized light beam L0 out of the light beam L0 as an irradiation light beam L2. The polarizing beam splitter 6 reflects an S-polarized light beam L0 so that it is incident on a mirror 10 as a reference light beam L1.

The mirror 10 reflects the reference light beam L1 so that it is incident on a rotating mirror 11. The rotating mirror 11 changes the angle of its reflecting surface 11a with respect to the reference light beam L1 (hereinafter, this angle will be referred to as reflecting surface angle) according to an applied voltage supplied from the control unit 2. The rotating mirror 11 can thus adjust the angle of incidence of the reference light beam L1 on an incident surface 15B of the hologram recording element 15a to an arbitrary angle. Incidentally, the angle of incidence shall be standardized (to 0°) when the optical axis of the reference light beam L1 and the incident surface 15B are orthogonal to each other.

In the meantime, the polarizing beam splitter 6 makes the transmitted irradiation light beam L2 incident on a half-wave plate 7.

The half-wave plate 7 converts the irradiation light beam L2 of P polarization into S polarization like the reference light beam L1, and makes it incident on an objective lens 9 of an objective lens selecting mechanism 8. The objective lens selecting mechanism 8 has four objective lenses 9A to 9D as objective lenses 9. The objective lens selecting mechanism 8 displaces the positions of the respective objective lenses 9 with respect to the irradiation light beam L2 by a not-shown drive mechanism, thereby switching the objective lens 9 for the irradiation light beam L2 to be incident on.

The objective lens 9 collects the irradiation light beam L2 so as to have a focal point at a predetermined focal length, and irradiates the hologram recording element 15a, which is arranged between the objective lens 9 and the focal point F2, with this irradiation light beam L2. The objective lens 9 is set to a numerical aperture of approximately 0.5 to 0.9. All the objective lenses 9 (9A to 9D) are set to the same numerical aperture NA in order to uniformize the spot sizes.

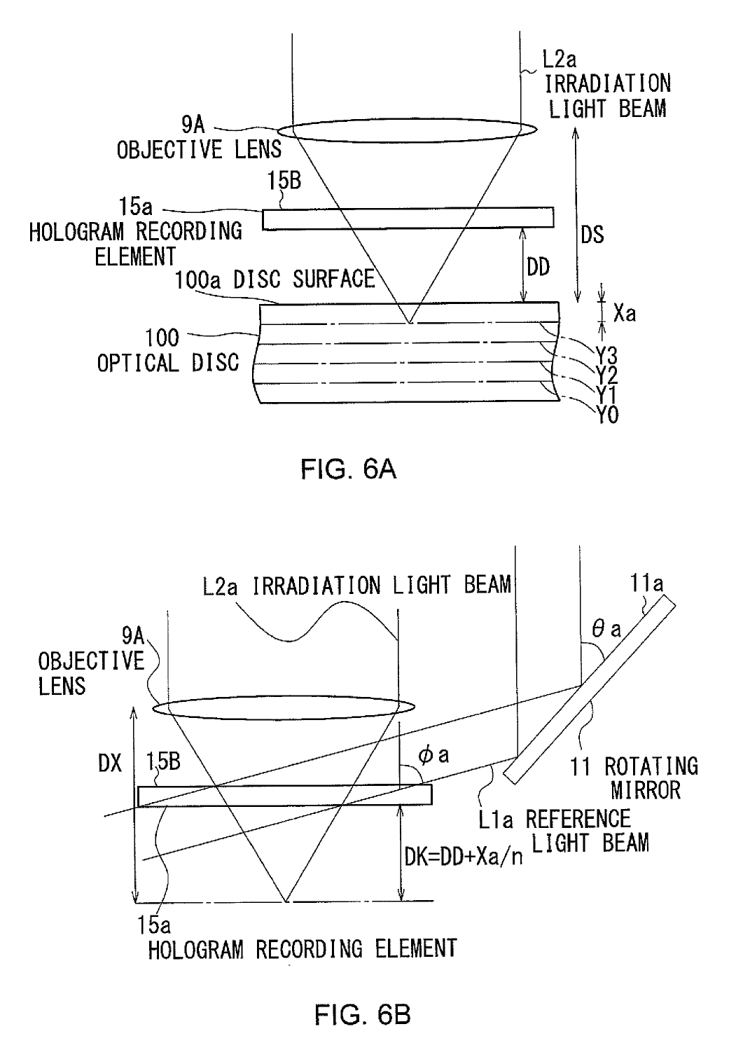

These objective lenses 9A to 9D are optimized and designed to the four signal recording layers Y0 to Y3 of the multilayer disc 100, respectively. For example, consider now the case shown in FIG. 6A, where the surface (hereinafter, referred to as disc surface) 100a of the multilayer disc 100 is located away from the objective lens 9A by a distance DS, and the hologram recording element 15a is located away from the disc surface 100a by a distance DD which is smaller than the distance DS.

The objective lens 9A has a focal length DX which is set so that the irradiation light beam L2a focuses on the signal recording layer Y3 when the multilayer disc 100 is irradiated with the irradiation light beam L2a through the hologram recording element 15a.

As shown in FIG. 6B, assuming that the in-disc depth from the disc surface 100a is Xa, a distance corresponding to the in-disc depth Xa in the air can be expressed as Xa/n. The focal length DX of the objective lens 9A in the air can be expressed as DS+Xa/n, where DS is the distance from the objective lens 9A to the disc surface 100a. Similarly, an inter-hologram distance DK between the hologram recording element 15a and the focal point F2a can be expressed as DD+Xa/n, which is the sum of the distance DD from the hologram recording element 15a to the disc surface 110a and the distance Xa/n.

The objective lens 9A is also designed so that the irradiation light beam L2 has near zero spherical aberration at the focal point F2 of the irradiation light beam L2 when the multilayer disc 100 is irradiated with the irradiation light beam L2. For example, the objective lens 9A is designed to give the irradiation light beam L2a a spherical aberration having an opposite sign to that of the spherical aberration that occurs in response to the in-disc depth Xa from the signal recording layer Y3 to the disc surface 100a.

In other words, the objective lens 9A projects the irradiation light beam L2a that is optimized to the signal recording layer Y3, assuming that the signal recording layer Y3 of the multilayer disc 100 will be irradiated with the irradiation light beam L2a. Specifically, the objective lens 9A projects the irradiation light beam L2a so that this irradiation light beam L2a has a focal point FB generally coincident with the signal recording layer Y3 and has zero spherical aberration in the vicinity of this focal point FB.

As shown in FIG. 6B, the rotating mirror 11 is set to a reflecting surface angle of θa. The reflecting surface 11a reflects the reference light beam L1, whereby the hologram recording element 15a is irradiated with the reference light beam L1a from the incident surface 15B where the irradiation light beam L2a is incident on, with an irradiation condition or angle of incidence of φa with respect to the hologram recording element 15a.

The hologram recording element 15a has the shape of a flat rectangular solid as a whole. The hologram recording element 15a is made of a photopolymer or the like that varies in refractive index depending on the intensity of the light irradiated with, and reacts with a blue light beam of 405 nm in wavelength.

More specifically, when the irradiation light beam L2a and the reference light beam L1a overlap each other to create an interference pattern on the hologram recording element 15a, the hologram recording element 15a photoreacts at areas where the interference pattern is high in light intensity, with a change in refractive index. In the meantime, the hologram recording element 15a makes no photoreaction at areas where the interference pattern is low in light intensity, without a change in refractive index.

Consequently, the hologram lens manufacturing apparatus 1 can record the interference pattern that is created by making the reference light beam L1a and the irradiation light beam L2a optimized to the signal recording layer Y3 overlap each other, onto the hologram recording element 15a as a hologram GMa. Incidentally, the surface of the hologram recording element 15a may be anti-reflection coated so as to avoid unnecessary reflection.

The control unit 2 (FIG. 5) then irradiates the hologram recording element 15a with the reference light beam L1a and the irradiation light beam L2a for a predetermined irradiation time before it controls the shutter 5 to block the light beam L0 and ends the recording of the hologram GMa on the hologram recording element 15a.

Consequently, when the hologram recording element 15a is irradiated with a reference light beam LA that has the same wavelength as that of the reference light beam L1a at an angle of incidence of φa, it can produce a diffracted light beam LB that is equivalent to the irradiation light beam L2a.

Next, the control unit 2 drives the objective lens selecting mechanism 8 (FIG. 5) to switch the objective lens 9 for the irradiation light beam L2 to be incident on to the objective lens 9B. The control unit 2 also drives the shutter 5 so that the shutter 5 transmits the light beam L0. As a result, the reference light beam L1 is incident on the rotating mirror 11 again, and the irradiation light beam L2 is incident on the objective lens 9B.

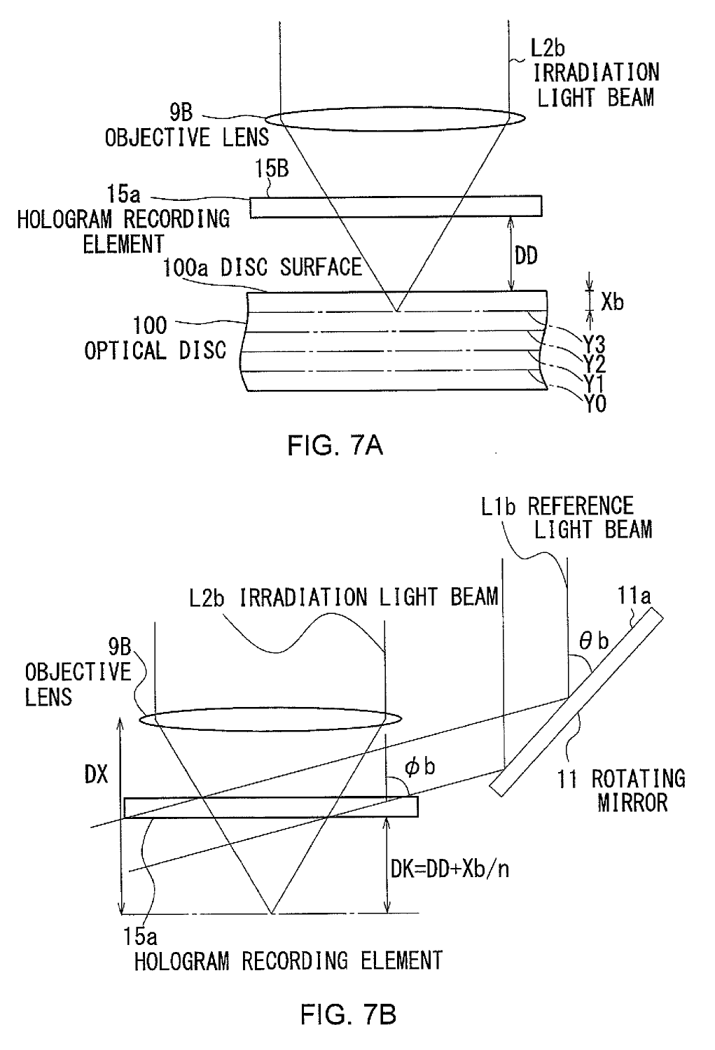

As shown in FIG. 7A, the focal length DX of the objective lens 9B is set so that the irradiation light beam L2b focuses on the signal recording layer Y2, the second layer from the disc surface 100a. The objective lens 9B also gives the irradiation light beam L2b a spherical aberration having an opposite sign to that of a spherical aberration that occurs in response to the in-disc depth Xb from the signal recording layer Y2 to the disc surface 100a.

As shown in FIG. 7B, the rotating mirror 11 reflects the reference light beam L1 with the reflecting surface 11a which is set to a reflecting surface angle of θb. The hologram recording element 15a is thereby irradiated with the reference light beam L1b which has an angle of incidence of φb approximately 1° greater than the angle φa.

Consequently, the hologram lens manufacturing apparatus 1 can record the interference pattern that is created by making the irradiation light beam L2b and the reference light beam L1b overlap each other, onto the hologram recording element 15a as a hologram GMb.

The control unit 2 (FIG. 5) then irradiates the hologram recording element 15a with the reference light beam L1b and the irradiation light beam L2b for a predetermined irradiation time before it controls the shutter 5 to block the light beam L0 and ends the recording of the hologram GMb on the hologram recording element 15a.

As a result, the hologram lens manufacturing apparatus 1 can form in the hologram recording element 15a the hologram GMb that results from the irradiation light beam L2b and the reference light beam L1b which have a focal length DX and an angle of incidence different from those of the irradiation light beam L2a and the reference light beam L1a, respectively.

The control unit 2 similarly switches the objective lens 9 to the objective lens 9C further, thereby irradiating the hologram recording element 15a with the irradiation light beam L2c which is optimized to the signal recording layer Y1. The control unit 2 also irradiates the hologram recording element 15a with the reference light beam L1c at an angle of incidence of φc. The hologram lens manufacturing apparatus 1 thereby records an interference pattern resulting from the irradiation light beam L2c and the reference light beam L1c onto the hologram recording element 15a as a hologram GMc.

The control unit 2 similarly switches the objective lens 9 to the objective lens 9D, thereby irradiating the hologram recording element 15a with the irradiation light beam L2d which is optimized to the signal recording layer Y0. The control unit 2 also irradiates the hologram recording element 15a with the reference light beam L1d at an angle of incidence of φd. The hologram lens manufacturing apparatus 1 thereby records an interference pattern resulting from the irradiation light beam L2d and the reference light beam L1d onto the hologram recording element 15a as a hologram GMd.

Consequently, the control unit 2 can manufacture a hologram lens 15 having four holograms GM (GMa to GMd) which are formed by the four pairs of combinations of irradiation light beams L2 (L2a to L2d) and reference light beams L1 (L1a to L1d).

The control unit 2 then waits for a request to start the hologram lens manufacturing processing on the next hologram recording element 15a.

As described above, the hologram lens manufacturing apparatus 1 sequentially irradiates the hologram recording element 15a with the pairs of combinations of irradiation light beams L2a to L2d which are optimized to the signal recording layers Y3 to Y0 of the multilayer disc 100, respectively, and reference light beams L1a to L1d which have angles of incidence φa to φd with respect to the hologram recording element 15, respectively.

The hologram lens manufacturing apparatus 1 thereby records the interference patterns created by the respective pairs of irradiation light beams L2a to L2d and reference light beams L1a to L1d, onto the hologram recording element 15a as the respective holograms GMa to GMd. The hologram lens manufacturing apparatus 1 can thus manufacture the hologram lens 15 which corresponds to the multilayer disc 100 having the four signal recording layers Y3 to Y0.

### (1-3) Configuration of Optical Disc Apparatus

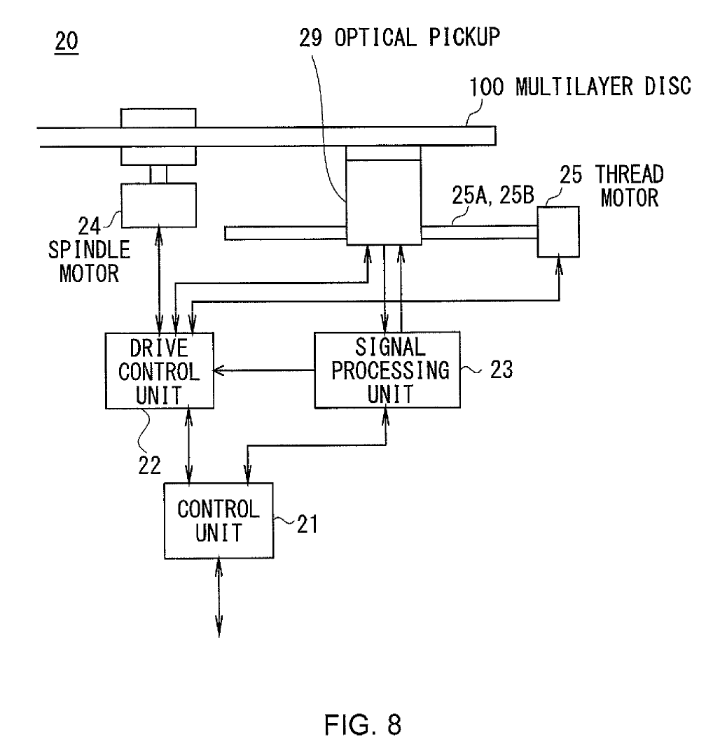

Next, description will be given of an optical disc apparatus 20 that is compatible with the foregoing multilayer disc 100. As shown in FIG. 8, the optical disc apparatus 20 includes a control unit 21 which exercises centralized control on the entire apparatus.

The control unit 21 is composed mainly of a not-shown central processing unit (CPU). The control unit 21 reads various programs such as a basic program and an information recording program from a not-shown read only memory (ROM), loads these programs into a not-shown random access memory (RAM), and thereby executes various types of processing such as information recording processing.

For example, with the multilayer disc 100 loaded, the control unit 21 accepts an information recording command, recording information, and recording address information from a not-shown external device or the like. The control unit 21 then supplies the recording address information and a drive command to a drive control unit 22, and supplies the recording information to a signal processing unit 23. Incidentally, the recording address information refers to information that indicates the address for the recording information to be recorded at, out of addresses assigned to a recording layer 101 of the multilayer disc 100.

According to the drive command, the drive control unit 22 performs drive control on a spindle motor 24, thereby rotating the multilayer disc 100 at a predetermined rotation speed. The drive control unit 22 also performs drive control on a thread motor 25, thereby moving an optical pickup 29 to a position corresponding to the recording address information in a radial direction of the multilayer disc 100 (i.e., radially inward or radially outward) along moving shafts 25A and 25B.

The signal processing unit 23 applies various types of signal processing such as predetermined encoding processing and modulation processing to the supplied recording information, thereby generating a recording signal. The signal processing unit 23 supplies this recording signal to the optical pickup 29.

The optical pickup 29 performs focus control and tracking control based on the control of the drive control unit 22 (FIG. 8). The optical pickup 29 thereby adjusts the recording mark position of a light beam to a track that is designated by the recording address information in the recording layer 101 of the multilayer disc 100 (hereinafter, this track will be referred to as target mark position), and records recording marks RM according to the recording signal from the signal processing unit 23 (details will be given later).

The control unit 21 also accepts an information reproduction command and reproduction address information which indicates the address of the recording information, from an external device (not shown), for example. The control unit 21 then supplies a drive command to the drive control unit 22, and supplies a reproduction processing command to the signal processing unit 23.

As is the case of recording information, the drive control unit 22 performs drive control on the spindle motor 24, thereby rotating the multilayer disc 100 at a predetermined rotation speed. The drive control unit 22 also performs drive control on the thread motor 25, thereby moving the optical pickup 29 to a position corresponding to the reproduction address information.

The optical pickup 29 performs focus control and tracking control based on the control of the drive control unit 22 (FIG. 8). The optical pickup 29 thereby adjusts the recording mark position of the light beam to a track that is designated by the reproduction address information in the signal recording layers Y0 to Y3 of the multilayer disc 100 (i.e., target mark position), and irradiates the target mark position with a predetermined amount of light beam. Here, the optical pickup 29 detects a reflected light beam which is reflected from the signal recording layers Y (Y0 to Y3) of the multilayer disc 100, and supplies a detection signal corresponding to the amount of the reflected light beam to the signal processing unit 23 (details will be given later).

The signal processing unit 23 applies various types of signal processing such as predetermined demodulation processing and decoding processing to the detection signal supplied, thereby generating reproduction information, and supplies the reproduction information to the control unit 21. In response, the control unit 21 sends out the reproduction information to an external device (not shown).

In this way, the optical disc apparatus 20 controls the optical pickup 29 through the control unit 21, thereby recording information on the target mark position on a signal recording layer Y of the multilayer disc 100 or reproducing information from the target mark position.

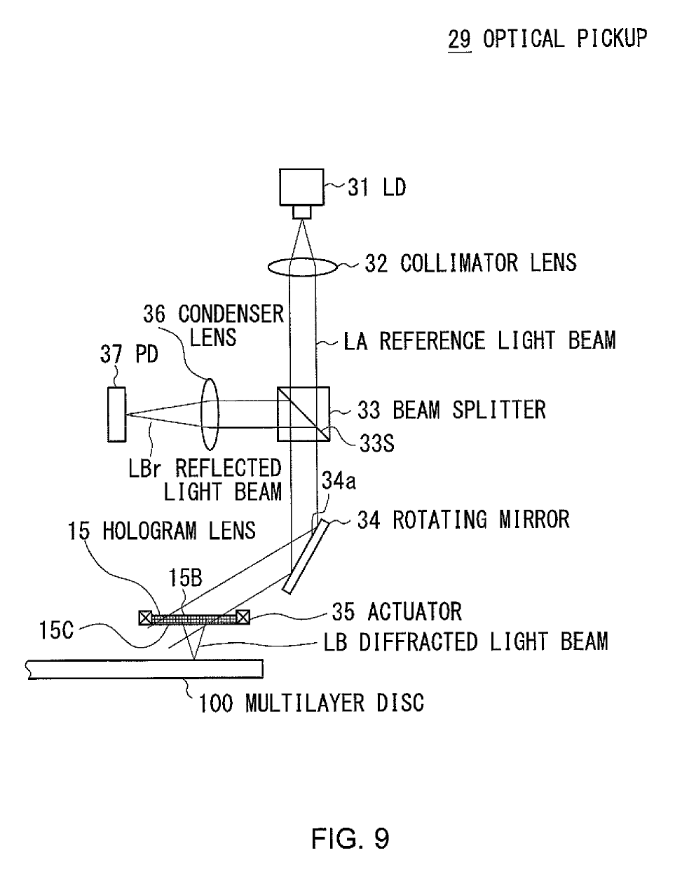

As shown in FIG. 9, a laser diode 31 of the optical pickup 29 emits a light beam having the same wavelength of 405 nm as that of the light beam that is used when manufacturing the hologram lens 15 under the control of the control unit 21. This light beam is incident on a collimator lens 32 as a reference light beam LA.

The collimator lens 32 converts the reference light beam LA of divergent light into parallel light and makes it incident on a beam splitter 33. The beam splitter 33 has a reflecting/transmitting surface 33S which transmits approximately 50% of the light beam and reflects the remaining approximately 50%. The beam splitter 33 transmits the reference light beam LA through the reflecting/transmitting surface 33S so that it is incident on a rotating mirror 34.

The rotating mirror 34 can change the angle of its reflecting surface 34a with respect to the reference light beam LA (i.e., reflecting surface angle) according to a mirror drive current which is supplied from the drive control unit 23. The rotating mirror 34 changes the angle of the reference light beam LA so that it is incident on the hologram lens 15. The hologram lens 15 then produces a diffracted light beam LB corresponding to the reference light beam LA, and irradiates the multilayer disc 100 with the diffracted light beam LB as a light beam.

As mentioned previously, the hologram lens 15 has four holograms GM (GMa to GMd) recorded thereon. Besides, the control unit 21 stores the reflecting surface angles θa to θd of the reflecting surface 11a of the rotating mirror 11 with which the hologram lens 15 is manufactured in the hologram lens manufacturing apparatus 1.

The rotating mirror 34 is arranged in the same positional relationship (distance and three-dimensional layout) to the hologram lens 15 as the rotating mirror 11 is to the hologram recording element 15a in the hologram lens manufacturing apparatus 1.

The control unit 21 selects an angle θ that corresponds to the signal recording layer Y to be irradiated with the light beam (hereinafter, this layer will be referred to as target recording layer) from among the angles θa to θd, and performs driving so that the reflecting surface angle of the reflecting surface 34a coincides with the selected angle θ.

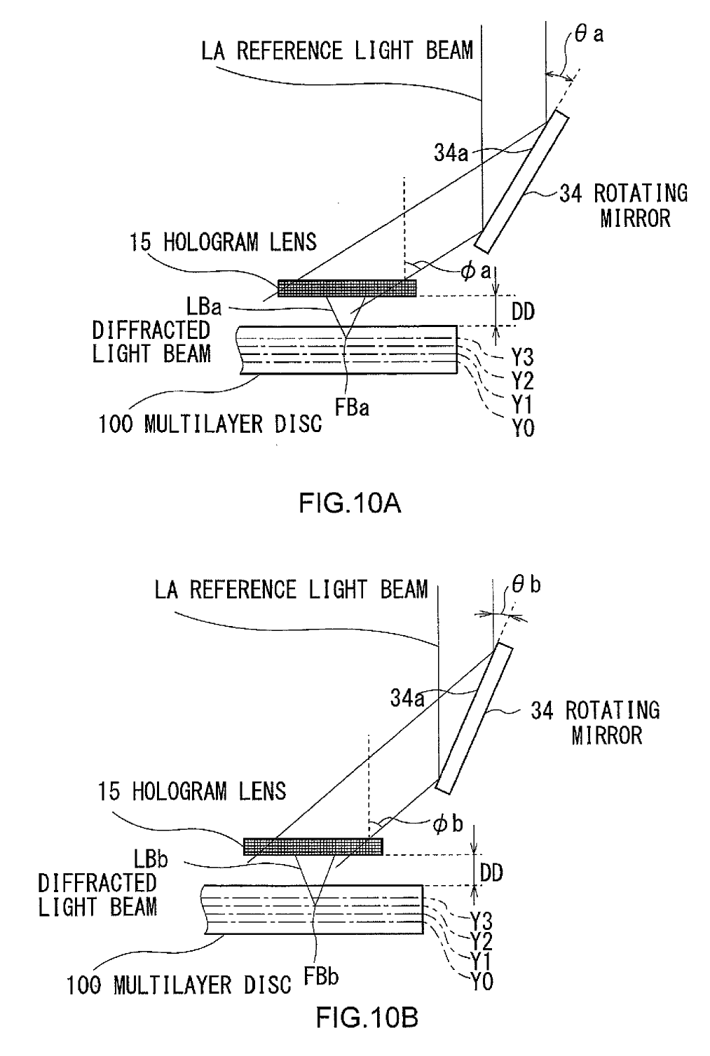

For example, as shown in FIG. 10A, when irradiating the signal recording layer Y3 with a diffracted light beam LB, the control unit 21 selects the angle θa of the reflecting surface 11a, which corresponds to the reference light beam L1a corresponding to the signal recording layer Y3, as the reflecting surface angle of the reflecting surface 34a. The control unit 21 then controls the drive control unit 22 so that the reflecting surface angle of the reflecting surface 34a coincides with the angle θa.

That is, the control unit 21 reflects the reference light beam LA at the same reflecting surface angle as with the reference light beam L1a, which is projected in the hologram lens manufacturing apparatus 1 along with the irradiation light beam L2a (FIG. 6A) that is optimized to the signal recording layer Y3.

The rotating mirror 34 reflects the reference light beam LA with the reflecting surface 34a at the angle θa, so that the resultant is incident on the hologram lens 15 as a reference light beam LAa.

The rotating mirror 34 can thus adjust the angle of incidence of the reference light beam LAa on the hologram lens 15 to the angle φa of the reference light beam L1a. That is, the optical pickup 29 can irradiate the hologram lens 15 with a light beam having the same properties as those of the reference light beam L1a (FIG. 6A) corresponding to the signal recording layer Y3, with which the hologram lens 15 is irradiated at the time of manufacturing of the hologram lens.

As a result, the hologram lens 15 can diffract the reference light beam LAa to produce a diffracted light beam LBa which has the same properties as those of the irradiation light beam L2a that is optimized to the signal recording layer Y3.

Here, the hologram lens 15 is located a distance DD away from the disc surface 100a. The focal length DX of the irradiation light beam L2a is determined so that the focal point F2a falls on the signal recording layer Y3 when the multilayer disc 100 is located a distance DD away from the hologram recording element 15a. The hologram lens 15 can thus form a focal point FBa on the signal recording layer Y3 as with the irradiation light beam L2a.

The irradiation light beam L2a is previously provided with a spherical aberration having an opposite sign to and generally the same amount as those of a spherical aberration that occurs according to the in-disc depth of the signal recording layer Y3 when the multilayer disc 100 is irradiated with the irradiation light beam L2a.

The hologram lens 15 can thus compensate the spherical aberration of the diffracted light beam LBa occurring in the multilayer disc 100 with the spherical aberration provided in advance, so that the diffracted light beam LBa has near zero spherical aberration at the signal recording layer Y3.

As shown in FIG. 10B, to irradiate the signal recording layer Y2 with a diffracted light beam LB, the control unit 21 selects the angle θb of the reflecting surface 11a at which the reference light beam L1b (FIG. 7B) corresponding to the signal recording layer Y2 is formed in the hologram lens manufacturing apparatus 1, as the reflecting surface angle of the reflecting surface 34a.

The rotating mirror 34 then reflects the reference light beam LA by the reflecting surface 34a. This can irradiate the hologram lens 15 with a reference light beam LAb at almost the same angle of incidence φb on the hologram lens 15 as with the reference light beam L1b.

Consequently, the hologram lens 15 can produce a diffracted light beam LBb that has the same properties as those of the irradiation light beam L2a, which focuses on the signal recording layer Y2 and has near zero spherical aberration at the signal recording layer Y2, with the focal length equal to the distance from the hologram lens 15 to the focal point FB. As a result, the hologram lens 15 can irradiate the signal recording layer Y2 with the diffracted light beam LBb having near zero spherical aberration.

As described above, the optical pickup 29 can correct the spherical aberration occurring in the multilayer disc 100 by irradiating the signal recording layers Y with diffracted light beams LB that have spherical aberrations corresponding to the in-disc depths of the respective signal recording layers Y in the multilayer disc 100.

Now, the hologram lens 15 (FIG. 9) also receives the diffracted light beam LB reflected by the signal recording layer Y, or a reflected light beam. The hologram lens 15 produces by diffraction a reflected diffracted light beam LBr which travels reversely to the reference light beam LA, and makes it incident on the rotating mirror 34.

The rotating mirror 34 changes the traveling direction of the reflected diffracted light beam LBr so that the reflected diffracted light beam LBr is incident on the beam splitter 33. The beam splitter 33 reflects approximately 50% of the reflected diffracted light beam LBr by the reflecting/transmitting surface 33S so that the reflected diffracted light beam LBr is incident on a condenser lens 36.

The condenser lens 36 collects the reflected diffracted light beam LBr and irradiates a photodetector 37 with it. The photodetector 37 has a plurality of detection areas. The photodetector 37 generates detection signals corresponding to the amount of the reflected diffracted light beam LBr in the respective detection areas, and supplies these signals to the signal processing unit 23.

The signal processing unit 23 generates a reproduction RF signal, a tracking error signal STE, and a focus error signal SFE from the detection signals, and supplies them to the drive control unit 22.

The drive control unit 22 generates various drive currents based on the tracking error signal STE and the focus error signal SFE supplied from the signal processing unit 23, and supplies them to the actuator 35.

The actuator 35 drives the hologram lens 15 in focus directions and tracking directions so that a desired track of the multilayer disc 100 is accurately irradiated with the light beam LB.

As mentioned previously, the hologram lens 15 can produce diffracted light beams LB that have focal lengths DK corresponding to the signal recording layers Y. Unlike typical objective lenses, the hologram lens 15 therefore need not be moved in the focus directions depending on the signal recording layer Y to be irradiated with the light beam. For this reason, the actuator 35 may fix the hologram lens 15 to a position a distance DD away from the disc surface 100a, and simply drive the hologram lens 15 in response to wobbling and the like of the multilayer disc 100. This can reduce the drive distance of the actuator 35.

Even if the hologram lens 15 is driven in the tracking direction in response to wobbling, eccentricity, or the like of the multilayer disc 100, it can constantly produce a diffracted light beam having the same properties as those of the irradiation light beam L2 as long as the hologram lens 15 can be irradiated with the reference light beam LA at the same angle of irradiation as when manufactured. This prevents the occurrence of aberrations ascribable to a deviation between the center of an objective lens and the optical axis of the light beam as is the case of an optical disc apparatus that uses a conventional objective lens. The hologram lens 15 can thus irradiate the multilayer disc 100 with a diffracted light beam LB of smaller aberration.

As described above, since the optical disc apparatus 20 uses the hologram lens 15 instead of an objective lens, it can irradiate each of the signal recording layers Y with a diffracted light beam LB of little spherical aberration and execute reproduction processing and recording processing on the multilayer disc 100, with the simple configuration of slightly changing the reflecting surface angle of the rotating mirror 34.

### (1-4) Operation and Effect

With the foregoing configuration, the hologram lens manufacturing apparatus 1 separates the light beam L0 emitted from the laser light source 3, a light source, into the reference light beam L1 and the irradiation light beam L2. The hologram lens manufacturing apparatus 1 collects the irradiation light beam L2 so as to have a focal point F2 at a predetermined focal position, and irradiates the hologram recording element 15a located on the way to the focal point F2 with the irradiation light beam L2.

The hologram lens manufacturing apparatus 1 also irradiates the hologram recording element 15a with the reference light beam L1 at an angle of incidence which is a predetermined irradiation condition on the hologram recording element 15a, thereby recording an interference pattern between the irradiation light beam L2 and the reference light beam L1 as a hologram.

Consequently, the hologram lens manufacturing apparatus 1 can manufacture a hologram lens 15 having a hologram GM recorded thereon, the hologram GM being capable of producing a diffracted light beam LB that has the same properties as those of the irradiation light beam L2 of convergent light when irradiated with a reference light beam LA having the same properties as those of the reference light beam L1.

That is, the hologram lens 15 can convert the reference light beam LA into the diffracted light beam LB of convergent light by means of diffraction. The hologram lens 15 can thus provide the same operation as that of what is called a lens which collects and converts a light beam into convergent light.

In addition, the hologram lens manufacturing apparatus 1 controls the objective lens selecting mechanism 8, which serves as an irradiation light irradiating unit, and the rotating mirror 11, which serves as a reference light irradiating unit, so as to irradiate the hologram recording element 15a with irradiation light beams L2 and reference light beams L1 of different focal positions and different angles of incidence.

The hologram lens manufacturing apparatus 1 can thus manufacture a hologram lens 15 on which a plurality of holograms GM are recorded in a superimposed fashion, the plurality of holograms GM resulting from a plurality of pairs of combinations of irradiation light beams L2 having different focal positions and reference light beams L1 having different angles of incidence.

That is, the hologram lens 15 can generate a plurality of diffracted light beams LB having different focal lengths DK, depending on the angle of incidence of the reference light beam LA incident thereon. The hologram lens 15 can thus irradiate an arbitrary focal position with a diffracted light beam LB by controlling the angle of incidence of the reference light beam LA.

Moreover, the hologram lens manufacturing apparatus 1 adds an aberration, or spherical aberration, to the irradiation light beam L2. This makes it possible for the hologram lens 15 to produce a diffracted light beam LB having an additional spherical aberration according to the irradiation of the reference light beam LA, so that it can operate as an aberration correcting mechanism as well as a lens.

For example, some BD-compatible optical disc apparatuses have a spherical aberration correcting mechanism which is composed of liquid crystal elements and is arranged on a light beam's optical path, so as to correct the spherical aberration that occurs depending on the signal recording layer Y to be recorded or reproduced. Liquid crystal elements, however, can only correct a limited range of spherical aberrations. It is therefore not possible to sufficiently correct spherical aberrations if the distance between positions where to form recording marks (hereinafter, these positions will be referred to as target mark positions) becomes greater as the signal recording layers increase in number or the stereoscopic mark recording layer increases in thickness.

The hologram lens manufacturing apparatus 1 can add different amounts of spherical aberration to the irradiation light beams L2a to L2d of different focal positions, respectively. This makes it possible for the hologram lens 15 to produce the diffracted light beams LBa to LBd with respective different amounts of spherical aberration. The hologram lens 15 can thus correct, for example, arbitrary amounts of spherical aberration corresponding to the signal recording layers Y with the respective diffracted light beams LBa to LBd.

The hologram lens manufacturing apparatus 1 provides spherical aberrations having opposite signs to and generally the same amounts as those of the spherical aberrations that are assumed to occur when the multilayer disc 100, the irradiation target, is irradiated with the irradiation light beams L2.

Since the hologram lens 15 can compensate the spherical aberrations occurring in the multilayer disc 100, it is possible to make the spherical aberrations in the vicinities of the focal points FB of the diffracted light beams LB near zero.

The hologram lens manufacturing apparatus 1 manufactures a hologram lens 15 that is intended to irradiate the multilayer disc 100, which is an optical information recording medium for recording information as recording marks RM, with a diffracted light beam LB.

Spherical aberrations occurring in the multilayer disc 100, if any, can hinder focusing of the light beam spot. Recording marks may vary in size depending on the spot size during information recording, and the light beam may be reflected by adjacent recording marks during information reproduction, causing a so-called crosstalk. Since the hologram lens 15 can make the spherical aberrations occurring inside the multilayer disc 100 near zero, it is possible to suppress crosstalk and variations in the size of a recording mark.

The hologram lens manufacturing apparatus 1 irradiates the hologram recording element 15a with the reference light beam L1 of parallel light while changing the angle of incidence of this reference light beam L1 on the hologram recording element 15a as an irradiation condition.

The hologram lens manufacturing apparatus 1 can thus change the irradiation condition of the reference light beam L1 easily with the simple configuration that the rotating mirror 11 is arranged in the prior stage of the hologram recording element 15a and the angle of the reflecting surface 11a of the rotating mirror 11 with respect to the optical axis of the reference light beam L1, or the reflecting surface angle, is only changed.

Since this angle of incidence has only to be changed slightly, the optical axis of the reference light beam L1 also shifts only slightly when the angle of incidence of the reference light beam L1 on the hologram recording element 15a is changed. It is therefore unnecessary to provide a wide optical path for the reference light beam L1 that is reflected by the rotating mirror 11, in preparation for the shift of the optical axis.

The optical pickup 29 is supposed to project the reference light beam LA that has the same properties as those of the reference light beam L1 under the same irradiation condition. The optical pickup 29 is also predicated on that it has almost the same configuration as that for projecting the reference light beam L1 in the hologram lens manufacturing apparatus 1. The hologram lens manufacturing apparatus 1 can thus simplify the configuration of the optical pickup 29 through the simplification of the configuration for projecting the reference light beam L1 in this hologram lens manufacturing apparatus 1.

The hologram lens manufacturing apparatus 1 irradiates the hologram recording element 15a with the reference light beam L1 from the incident surface 15B, which is the incident surface where the irradiation light beam L2 is incident on. Since the hologram lens manufacturing apparatus 1 can irradiate the hologram recording element 15a with the reference light beam L1 and the irradiation light beam L2 from the same side, it is unnecessary to route either one of the reference light beam L1 and the irradiation light beam L2 to the other side of the hologram recording element 15a.

The hologram lens manufacturing apparatus 1 can thus reduce the total length of the optical paths of the reference light beam L1 and the irradiation light beam L2, so that the hologram lens manufacturing apparatus 1 can be simplified in configuration.

In the optical pickup 29, the hologram lens 15 is irradiated with the reference light beam LA from the incident surface 15B, and emits a diffracted light beam LB from the emission surface 15C on the opposite side. The hologram lens 15 will not reverse the traveling directions of the reference light beam LA and the diffracted light beam LB which occurs in response to the irradiation of this reference light beam LA. This can reduce the optical path length of the entire optical pickup 29, and can simplify the configuration of the optical pickup 29.

The hologram lens manufacturing apparatus 1 has the plurality of objective lenses 9 (9A to 9D) which are designed to near optimum spherical aberrations depending on the focal lengths DX. When recording a hologram GM, the focal length DX is changed by switching the objective lens 9 to collect the irradiation light beam L2.

Consequently, the hologram lens manufacturing apparatus 1 can irradiate the hologram lens 15 with irradiation light beams L2 that are collected by using the plurality of objective lenses 9. The hologram lens 15 can thus produce a plurality of diffracted light beams LB having the same properties as those of the irradiation light beams L2 that are optimized by using the plurality of objective lenses 9.

That is, the single hologram lens 15 by itself can reproduce the irradiation light beams L2 that are generated by using the plurality of objective lens 9 as the diffracted light beams LB, and can produce the same light beams as with the plurality of objective lenses.

Now, in the optical disc apparatus 20, the hologram lens 15 is opposed to the multilayer disc 100, and a light beam having the same wavelength as that of the reference light beam L2 is emitted from the laser diode 31 as the reference light beam LA. The optical disc apparatus 20 controls the angle of incidence of the reference light beam LA with respect to the hologram lens 15, thereby irradiating the hologram lens 15 with the reference light beam LA under a predetermined irradiation condition. The optical disc apparatus 20 thereby makes the hologram lens 15 produce a diffracted light beam LB having a predetermined focal length DK, and irradiates the multilayer disc 100 with the diffracted light beam LB.

Consequently, the optical disc apparatus 20 can use the hologram lens 15 instead of an objective lens for converting a light beam into convergent light.

With the foregoing configuration, the hologram lens manufacturing apparatus 1 manufactures the hologram lens 15 by recording an interference pattern occurring between the reference light beam L1 projected at a predetermined angle of incidence and the irradiation light beam L2 of convergent light, onto the hologram recording element 15a. When the hologram lens 15 is irradiated with a light beam having the same properties as those of the reference light beam L1, it can therefore diffract this light beam to produce a diffracted light beam LB that has the same properties as those of the irradiation light beam L2 of convergent light. In consequence, according to the first embodiment of the present invention, it is possible to achieve a hologram lens which can produce a light beam of convergent light, a hologram lens manufacturing apparatus and a method of manufacturing a hologram lens for manufacturing such a hologram lens, and an information recording apparatus and an information reproducing apparatus which use such a hologram lens.

### (1-5) Other Embodiments

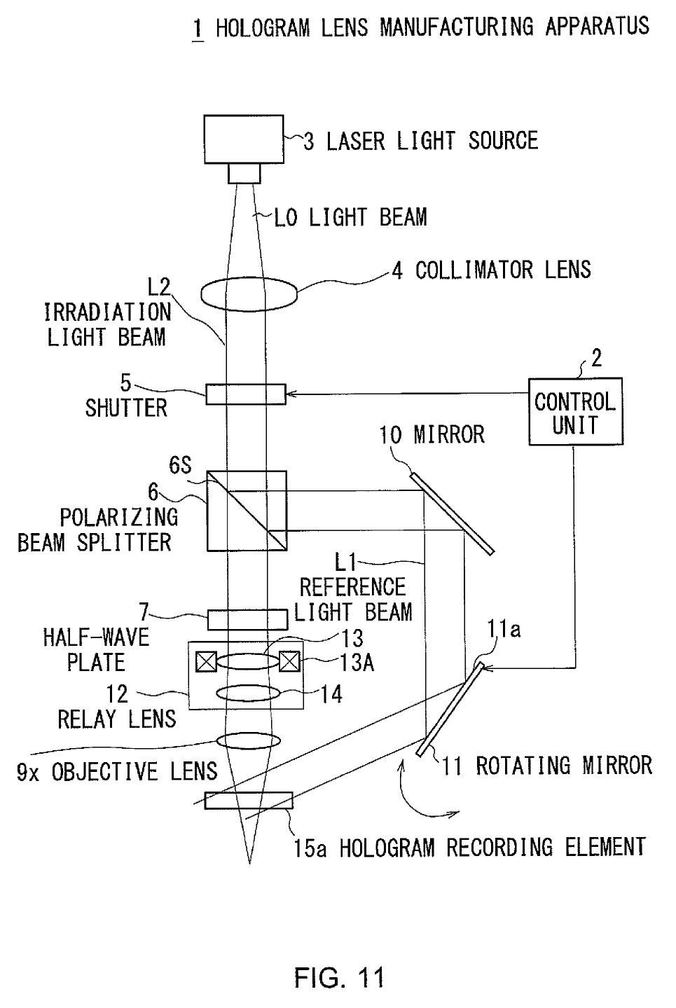

The foregoing first embodiment has dealt with the case where the hologram lens manufacturing apparatus 1 adds spherical aberrations corresponding to the respective signal recording layers Y to the irradiation light beam L2 by switching the objective lenses 9. However, the present invention is not limited thereto. For example, as shown in FIG. 11, the hologram lens manufacturing apparatus 1 may include a single objective lens 9x which has no switching mechanism, and a relay lens 12 which is composed of a movable lens 13 capable of being driven and a fixed lens 14 and is arranged in the prior stage of the objective lens 9x.

The hologram lens manufacturing apparatus 1 then changes the state of convergence of the irradiation light beam L2 with the relay lens 12, thereby changing the focal length DX of the irradiation light beam L2 to be collected by the objective lens 9x. The objective lens 9x is designed to provide a spherical aberration having an opposite sign to and the same amount as those of the spherical aberration that occurs in the multilayer disc 100 depending on the focal length DX which is determined by changing the state of convergence of the irradiation light beam L2.

As a result, the hologram lens manufacturing apparatus 1 can irradiate the hologram recording element 15a with the irradiation light beam L2 that has near optimum spherical aberration by displacing the movable lens 13 according to the focal length DX of the irradiation light beam L2.

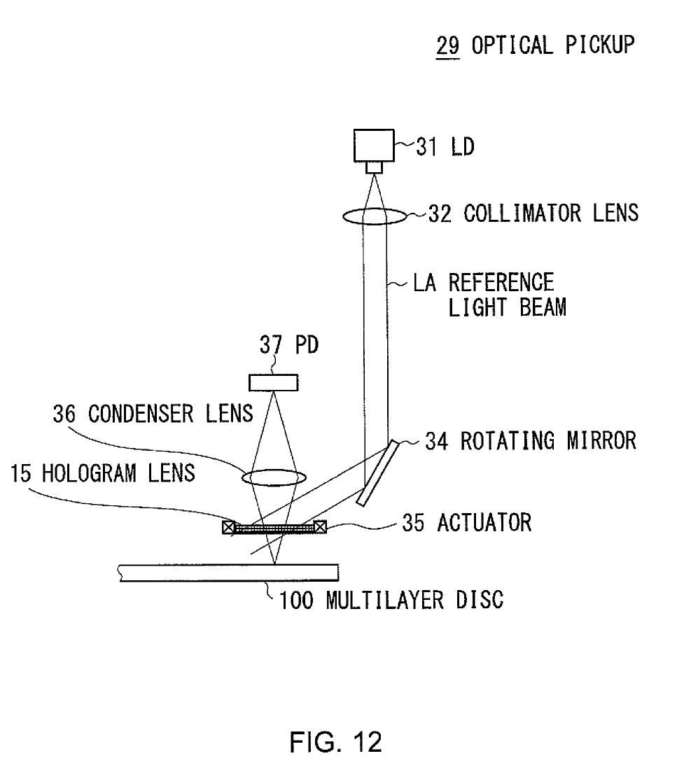

The foregoing first embodiment has also dealt with the case where the reflected diffracted light beam LBr, which is the reflected light beam diffracted by the hologram lens 15, is received by the photodetector 37. However, the present invention is not limited thereto. As shown in FIG. 12, the reflected light beam transmitted through the hologram lens 15 may be collected by the condenser lens 36 and received by the photodetector 37.

The foregoing first embodiment has also dealt with the case where the hologram recording element 15a has a flat rectangular solid shape. The present invention is not limited thereto, however, and there is no particular limitation in shape. For example, the hologram recording element 15a may have various shapes such as a flat cylindrical shape, a prismatic shape with a rhombic or trapezoidal base, and an elliptic spherical shape.

The foregoing first embodiment has also dealt with the case where the angles φa and φb have a difference of approximately 1°. However, the present invention is not limited thereto. For example, when the hologram recording element 15a has a thickness of 1.0 mm, the angles φa and φb have only to have a difference of at least approximately 0.1°. The thicker the hologram recording element 15a is, the smaller the difference between the angles φa and φb may be. The thinner the hologram recording element 15a is, the greater the difference between the angles φa and φb needs to be. Note that the thickness of this hologram recording element 15a may be determined freely.

The foregoing first embodiment has also dealt with the case where the traveling direction of the reference light beam L1 emitted orthogonally to the hologram recording element 15a is changed by the rotating mirror 11 which is arranged to face the incident surface 15B of the hologram recording element 15a. However, the present invention is not limited thereto. For example, the traveling direction of a reference light beam L1 that is emitted in parallel with the incident surface 15B of the hologram recording element 15a may be changed by a rotating mirror which is arranged to face the side opposite to the incident surface 15B. This can make the hologram lens manufacturing apparatus 1 low profile, and the optical pickup 29 having the rotating mirror 34 of the same function low profile.

The foregoing first embodiment has also dealt with the case where a plurality of holograms GM are recorded on the hologram recording element 15a. However, the present invention is not limited thereto. For example, a single hologram GM alone may be recorded on the hologram lens 15.

The foregoing first embodiment has also dealt with the case where the hologram lens manufacturing apparatus 1 changes the angle of incidence of the reference light beam L1 on the hologram recording element 15a by using the rotating mirror 11. However, the present invention is not limited thereto. For example, a diffractive element for diffracting an incident light beam at a predetermined angle may be used. A special mirror may be used, such as one that has a plurality of reflecting surfaces and switches the reflectances thereof depending on the application of voltage.

The foregoing first embodiment has also dealt with the case of adding a spherical aberration to the irradiation light beam L2. However, the present invention is not limited thereto. For example, various types of aberrations such as coma aberration and astigmatic aberration may be added. Aberrations need not necessarily be added at all. It is essential only that aberrations occurring from the irradiation target be corrected as needed.

The foregoing first embodiment has also dealt with the case of performing so-called angle multiplexing where holograms GM are recorded in a multiple fashion by changing the angle of incidence of the reference light beam L1 with respect to the hologram recording element 15a. However, the present invention is not limited thereto. For example, the hologram lens manufacturing apparatus 1 may record holograms GM in a multiple fashion by changing the positions of the holograms GM in the hologram recording element 15a. The hologram lens manufacturing apparatus 1 may record holograms GM in a multiple fashion by changing the state of convergence of the reference light beam L1 that is projected as slightly-diverting divergent light or slightly-converging convergent light.

The foregoing first embodiment has also dealt with the case where the objective lenses 9 are switched according to the focal lengths DX of the irradiation light beam L2 in a one-to-one correspondence. However, the present invention is not limited thereto. For example, an identical objective lens 9 may be used for the signal recording layers Y3 and Y2 which have relatively similar in-disc depths. In this case, spherical aberrations may be added by a correcting mechanism which is provided separately. This can reduce the number of objective lenses 9 required, thereby simplifying the configuration of the hologram lens manufacturing apparatus 1.

The foregoing first embodiment has also dealt with the case of using a 405-nm blue light beam. However, the present invention is not limited thereto. The light beam to be used is not limited to any particular wavelength, and may be a red light beam or an infrared light beam, for example. The wavelength may be selected as appropriate depending on the characteristics of the optical information recording medium, the sizes of the recording marks RM, and so on.

The foregoing first embodiment has also dealt with the case where the hologram lens 15 is used for the optical pickup 29 that is compatible with the multilayer disc 100 having a plurality of signal recording layers. However, the present invention is not limited thereto. For example, the hologram lens 15 may be used for an optical pickup which forms recording marks RM of pores by the irradiation of a light beam. The hologram lens 15 may also be used for an optical pickup which irradiates with a light beam an optical disc 200 that has holograms recorded on its entire recording layer in advance, so that the holograms are collapsed to form recording marks RM in the irradiated areas.

The foregoing first embodiment has also dealt with the case where the hologram lens 15 irradiates the optical disc with the light beam. However, the present invention is not limited thereto. In essence, the hologram lens 15 may be used for any photoelectric apparatus which irradiates an irradiation target with convergent light.

The foregoing first embodiment has also dealt with the case where the hologram lens manufacturing apparatus 1 as a hologram lens manufacturing apparatus includes the polarizing beam splitter 6 as a separation unit, the objective lens selecting mechanism 8 as an irradiation light irradiating unit, and the rotating mirror 11 as a reference light irradiating unit. However, the present invention is not limited thereto. Various other types of separation units, irradiation light irradiating units, and reference light irradiating units may be used to constitute a hologram lens manufacturing apparatus according to the first embodiment of the present invention.

The foregoing first embodiment has also dealt with the case where the hologram lens 15 as a hologram lens contains the hologram GMa as a single hologram. However, the present invention is not limited thereto. A hologram lens according to the embodiment of the present invention may contain a single hologram of various other configurations.

The foregoing first embodiment has also dealt with the case where the optical disc apparatus 20 as an information recording apparatus includes the hologram lens 15 as a hologram lens, the laser diode 31 as a light source, and the rotating mirror 34 as an irradiating unit. However, the present invention is not limited thereto. Various other types of hologram lenses, light sources, and irradiating units may be used to constitute an information recording apparatus according to the first embodiment of the present invention.

The foregoing first embodiment has also dealt with the case where the optical disc apparatus 20 as an information reproducing apparatus includes the hologram lens 15 as a hologram lens, the laser diode 31 as a light source, the rotating mirror 34 as an irradiating unit, and the photodetector 37 as a light detection unit. However, the present invention is not limited thereto. Various other types of hologram lenses, light sources, irradiating units, and optical detection units may be used to constitute an information reproducing apparatus according to the first embodiment of the present invention.

### (2) Second Embodiment

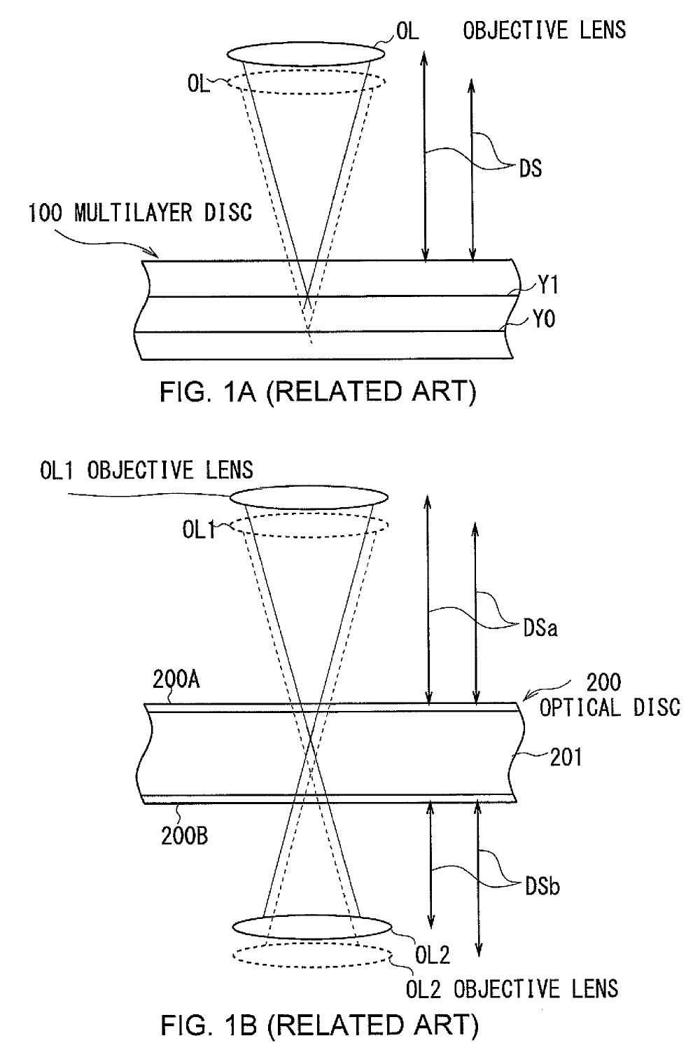

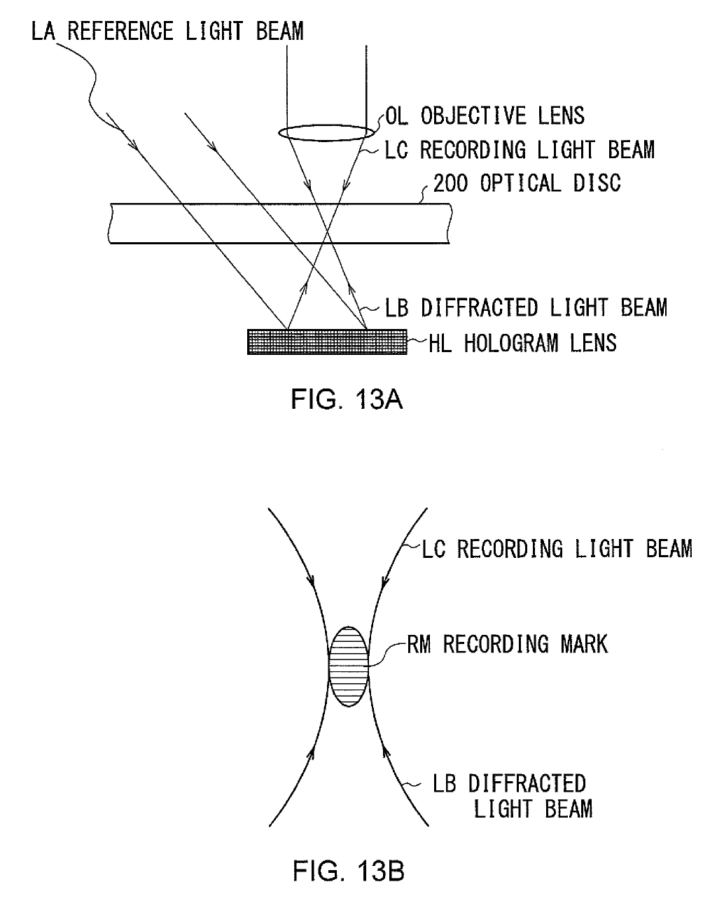

FIGS. 13A to 22 show a second embodiment. Parts corresponding to those of the first embodiment shown in FIGS. 1 to 12 will be designated by like reference numerals, and redundant description will be omitted. An optical disc apparatus 20X has the same configuration as that of the first embodiment, and description thereof will thus be omitted.

As shown in FIG. 13A, an optical pickup 39 according to the second embodiment separates a light beam emitted from a single light source into a reference light beam LA and a recording light beam LC. The optical pickup 39 irradiates a hologram lens HL with the reference light beam LA to produce a diffracted light beam LB.

The optical pickup 39 projects the diffracted light beam LB and the recording light beam LC so that the focal point FB of the diffracted light beam LB and the focal point FC of the recording light beam LC fall on an identical target mark position, thereby creating an interference pattern in the vicinity of the focal points. As shown in FIG. 13B, the optical pickup 39 thereby forms a stereoscopic recording mark RM which is made of a hologram.

In the second embodiment, the optical pickup 39 (FIG. 13A) once makes the reference light beam LA pass through an optical disc 200 before irradiating the hologram lens HL with the reference light beam LA.

### (2-1) Configuration of Optical Disc

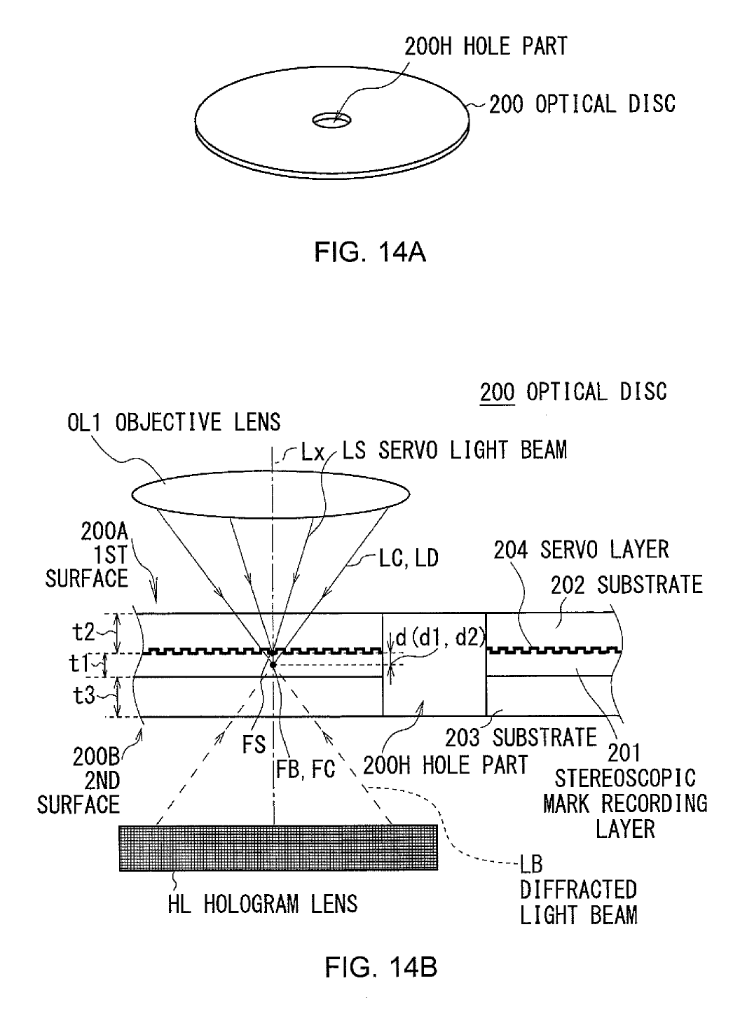

Initially, description will be given of the optical disc 200 which is used as an optical information recording medium in the second embodiment of the present invention. As shown in the external view of FIG. 14A, the optical disc 200 is configured in a disc shape having a diameter of approximately 120 mm like conventional CD, DVD, and BD as a whole. A hole part 200H is formed in the center area.

As shown in the sectional view of FIG. 14B, the optical disc 200 has at its center a stereoscopic mark recording layer 201 for recording information. The stereoscopic mark recording layer 201 is sandwiched between substrates 202 and 203 on both sides.

Incidentally, the stereoscopic mark recording layer 201 has a thickness t1 of approximately 0.3 mm. The substrates 202 and 203 have thicknesses t2 and t3 of approximately 0.6 mm each.

The substrates 202 and 203 are made of a material having a high transmittance such as polycarbonate and glass. The substrates 202 and 203 are intended to protect the stereoscopic mark recording layers 201 and maintain the physical strength of the optical disc 200.

The stereoscopic mark recording layer 201 is made of a photopolymer or the like that varies in refractive index depending on the intensity of the light irradiated with, and reacts with a blue light beam of 405 nm in wavelength. As shown in FIG. 14B, when two light beams, namely, a diffracted light beam LB and a recording light beam LC of relatively high intensity interfere with each other inside the stereoscopic mark recording layer 201, a standing wave occurs in the stereoscopic mark recording layer 201. This creates an interference pattern having the properties of a hologram.

The optical disc 200 has a servo layer 204 at the interface between the stereoscopic mark recording layer 201 and the substrate 202. The servo layer 204 is made of a dielectric multilayer film or the like. The servo layer 204 has the wavelength selectivity of transmitting the diffracted light beam LB and the recording light beam LC of 405 nm in wavelength, and reflecting a red light beam of 660 nm in wavelength.

The servo layer 204 also has a guide groove intended for tracking servo. Specifically, the servo layer 204 has the same land-and-groove tracks of spiral form as those of a typical BD recordable (BD-R) disc or the like, for example. A series of numbers or addresses are assigned to the tracks in units of predetermined recording units so that which track to record or reproduce information on/from can be identified from the addresses.

When this servo layer 204 is irradiated with a servo light beam LS from the side of the substrate 202, it reflects this light beam to the side of the substrate 202. Hereinafter, this light beam reflected will be referred to as servo reflected light beam LSr.

The servo reflected light beam LSr is intended for use in positional control (i.e., focus control and tracking control) on a predetermined objective lens OL1 of an optical disc apparatus, for example. By this positional control, the focal point Fr of the servo light beam LS collected through the objective lens OL1 is adjusted to an intended track (hereinafter, referred to as target track).

Incidentally, the disc surface of the optical disc 200 on the side of the substrate 202 will hereinafter be referred to as first surface 200A. The disc surface of the optical disc 200 on the side of the substrate 203 will be referred to as second surface 200B.

In fact, when recording information on the optical disc 200, the servo light beam LS is collected by the position-controlled objective lens OL1 so as to focus on the target track of the servo layer 204 as shown in FIG. 14B.

The recording light beam LC has an optical axis Lx in common with the servo light beam LS. The recording light beam LC is also collected by the objective lens OL1, and is transmitted through the substrate 202 and the servo layer 204 so as to focus on a position behind the desired track in the stereoscopic mark recording layer 201. Here, the focal point FC of the recording light beam LC is positioned farther than the focal point FS on the common optical axis Lx with respect to the objective lens OL1.

The diffracted light beam LB and the recording light beam LC have the same wavelength and have the optical axis Lx in common. The diffracted light beam LB is projected from the opposite side of the recording light beam LC (i.e., the side of the substrate 203) through the hologram lens HL. Here, the focal point FB of this diffracted light beam LB is located at the same position as that of the focal point FC of the recording light beam LC by means of position control on the hologram lens HL.

As a result, as shown in FIG. 13B, a recording mark RM made of a relatively small interference pattern (for example, with a diameter RMr of approximately 1 μm and a height RMh of approximately 9.7 μm) is recorded on the optical disc 200, at the position of the focal points FC and FB behind the target track in the stereoscopic mark recording layer 201.

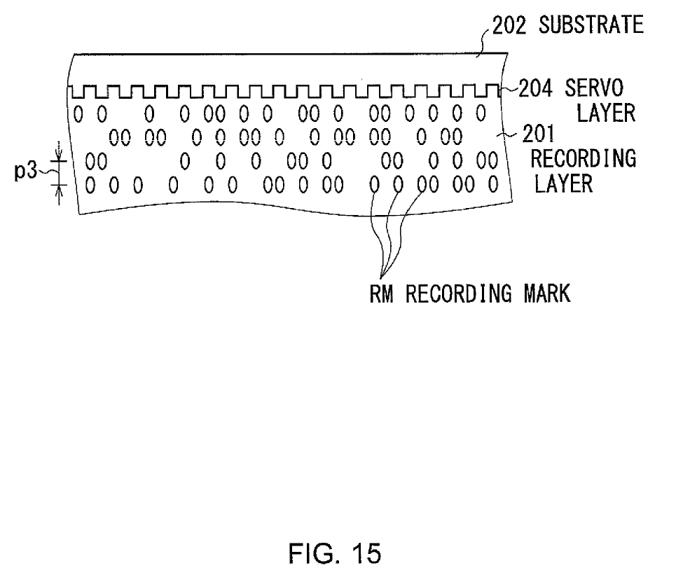

The optical disc 200 is designed so that the stereoscopic mark recording layer 201 has a thickness of t1 (=0.3 mm) which is sufficiently greater than the height RMh of the recording mark RM. By forming recording marks RM while switching the distance (hereinafter, referred to as depth) d from the servo layer 204 in the stereoscopic recording layer 201, it is possible to perform multiple recording on the optical disc 200 such that a plurality of mark recording layers are stacked in the thickness direction of the optical disc 200 as shown in FIG. 15.

Here, the depths of the recording marks RM are changed by adjusting the depths d (FIG. 14B) of the focal points FC and FB of the recording light beam LC and the diffracted light beam LB in the stereoscopic mark recording layer 201 of the optical disc 200. For example, if apparent mark recording layers are located at intervals p3 (FIG. 15) of approximately 15 μm therebetween, with consideration given to mutual interference and the like between the recording marks RM, then the optical disc 200 can form approximately 20 mark recording layers in the stereoscopic mark recording layers 201.

Now, when reproducing information from the optical disc 200, the objective lens OL1 is controlled in position so that the servo light beam LS collected by the objective lens OL1 focuses on the target track of the servo layer 204 as with the case of recording the information.

A reproducing light beam LD is passed through the same objective lens OL1 and transmitted through the substrate 202 and the servo layer 204 of the optical disc 200. The reproducing light beam LD is focused so that its focal point FC falls on the target mark position that is “behind” the target track and at the target depth in the stereoscopic mark recording layer 201.

Here, the recording mark RM recorded at this target position produces a reproduced diffracted light beam LBv because of its properties as a hologram. This reproduced diffracted light beam LBv has the same optical characteristics as those of the diffracted light beam LB that is projected when recording the recording mark RM, and travels in the same direction as that of the diffracted light beam LB, i.e., toward the substrate 202 from inside the stereoscopic mark recording layer 201 with divergence.

As described above, when recording information on the optical disc 200, the servo light beam LS intended for position control and the recording light beam LC and diffracted light beam LB intended for information recording are used to form a recording mark RM as the information at the position where the focal points FC and FB coincide with each other in the stereoscopic mark recording layer 201, i.e., at the target mark position that is behind the target track of the servo layer 204 and at the target depth.

When reproducing recorded information from the optical disc 200, the servo light beam LS intended for position control and the reproducing light beam LD intended for information reproduction are used to produce a reproduced diffracted light beam LBv from the recording mark RM that is recorded at the position of the focal point FD, i.e., at the target mark position.

### (2-2) Configuration of Hologram Lens Manufacturing Apparatus

As described above, according to the second embodiment, the optical pickup 39 irradiates the hologram lens HL with the reference light beam LA that is transmitted through the optical disc 200.

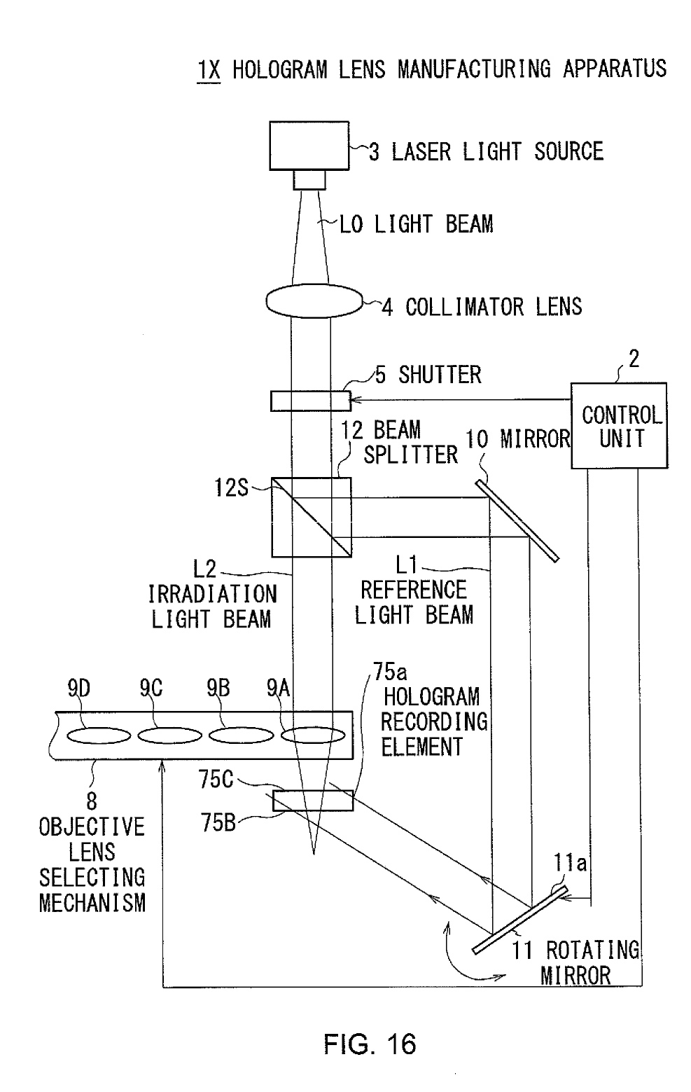

For this reason, as shown in FIG. 16, a hologram lens manufacturing apparatus 1X according to the second embodiment manufactures a hologram lens 75 by making a reference light beam L1 pass through the optical disc 200 as with the reference light beam LA of the optical pickup 39, and irradiating a hologram recording element 75a with the reference light beam L1.

Specifically, the hologram lens manufacturing apparatus 1X emits a light beam L0 from a laser light source 3 so that this light beam L0 is incident on a beam splitter 12 through a collimator lens 4 and a shutter 5.

The beam splitter 12 transmits approximately 50% of a light beam and reflect approximately 50% of the light beam through/at a reflecting/transmitting surface 12S thereof. The beam splitter 12 then transmits approximately 50% of the light beam L0 as an irradiation light beam L2, and irradiates the hologram recording element 75a with the irradiation light beam L2 through an objective lens 9.

The beam splitter 12 reflects the remaining approximate 50% of the light beam L0 as a reference light beam L1 so that it is incident on a rotating mirror 11 via a mirror 10.

The rotating mirror 11 reflects the reference light beam L1 with its reflecting surface 11a, thereby changing the traveling direction of the reference light beam L1 so that the hologram recording element 75a is irradiated with the reference light beam L1 from a backside 75C opposite to an opposed surface 75B where the irradiation light beam L2 is incident on.

As mentioned previously, the optical disc 200 is predicated on that recording marks RM are formed across the apparent mark recording layers in the thickness direction of the optical disc 200. The control unit 2 then controls the angle of reflection θ of the rotating mirror 11 in 20 possible angles, and sequentially switches between 20 objective lenses 9 of an objective lens selecting mechanism 8.

The control unit 2 thereby combines 20 reference light beams L1 having 20 angles of incidence with 20 irradiation light beams L2 having 20 focal lengths and spherical aberrations. As a result, the control unit 2 records interference patterns created by the 20 pairs of reference light beams L1 and irradiation light beams L2 on the hologram recording element 75a as holograms GM, thereby forming the hologram lens 75.

### (2-3) Configuration of Optical Pickup

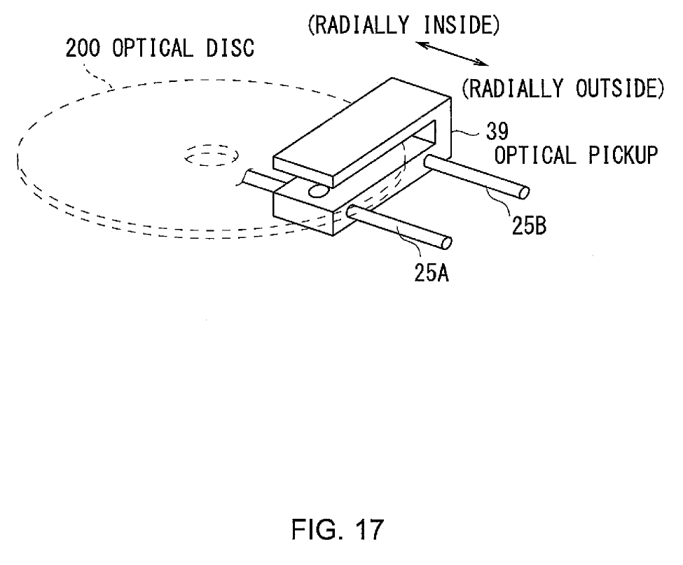

Next, description will be given of the configuration of the optical pickup 39. As shown in FIG. 17, the optical pickup 39 is formed in a generally U-shape when viewed sideways. The optical pickup 39 can irradiate the optical disc 200 with the diffracted light beam LB and the recording light beam LC in focus from both sides as shown in FIG. 14B.

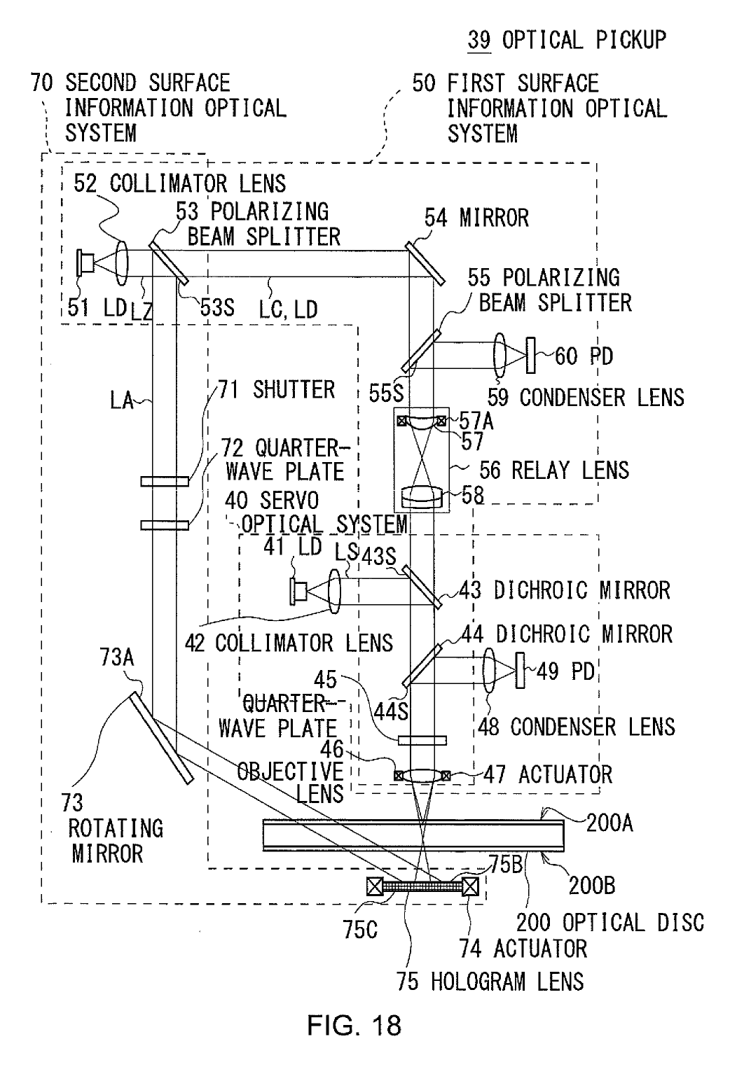

As schematically shown in FIG. 18, the optical pickup 39 includes a large number of optical components, which are broadly classified into a servo optical system 40, a first surface information optical system 50, and a second surface information optical system 70.

### (2-3-1) Tracking Control

The servo optical system 40 irradiates the first surface 200A of the optical disc 200 with the servo light beam LS, and receives the servo reflected light beam LSr which is the servo light beam LS reflected by the optical disc 200.

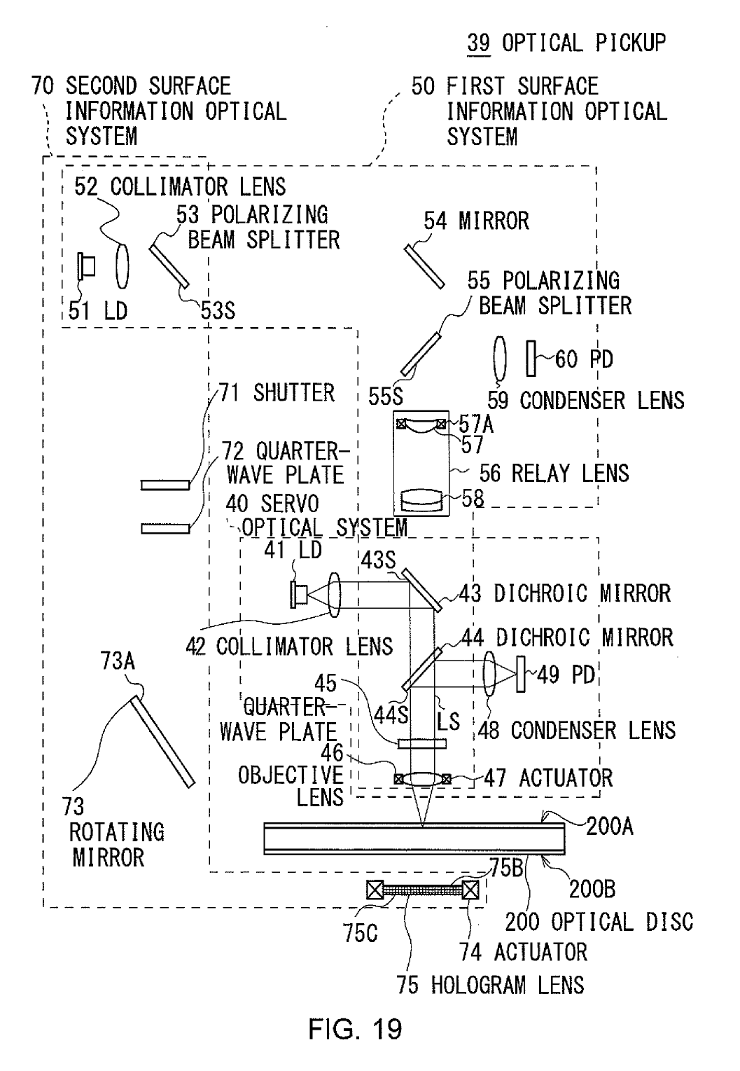

In FIG. 19, a laser diode 41 of the servo optical system 40 can emit P-polarized red laser light of approximately 660 nm in wavelength. In fact, the laser diode 41 emits a predetermined amount of servo light beam LS of divergent light based on the control of the control unit 21 (FIG. 8) so that it is incident on a collimator lens 42. The collimator lens 42 converts the servo light beam LS from divergent light into parallel light, and makes it incident on a dichroic mirror 43.

The dichroic mirror 43 varies in transmittance and reflectance depending on the wavelength of a light beam, i.e., has a so-called wavelength selectivity. The dichroic mirror 43 reflects almost 100% of a red light beam having a wavelength of approximately 660 nm and transmits almost 100% of a blue light beam having a wavelength of approximately 405 nm. The dichroic mirror 43 then reflects the servo light beam LS so that it is incident on a dichroic mirror 44.

The dichroic mirror 44 transmits or reflects a light beam at different ratios depending on the direction of polarization of the light beam, aside from wavelength selectivity. The dichroic mirror 44 transmits almost 100% of a P-polarized red light beam and reflects almost 100% of an S-polarized red light beam. The dichroic mirror 44 also transmits almost 100% of a blue light beam regardless of whether P-polarized or S-polarized.

The dichroic mirror 44 then transmits the servo light beam LS of P polarization so that it is incident on a quarter-wave plate 45.

The quarter-wave plate 45 converts both a red light beam and a blue light beam from linear polarization into circular polarization or from circular polarization into linear polarization. The quarter-wave plate 45 then converts the servo light beam LS of P polarization into circular polarization (for example, right-handed circular polarization), and makes it incident on an objective lens 46.

The objective lens 46 collects the servo light beam LS and projects it toward the first surface 200A of the optical disc 200. Here, as shown in FIG. 14B, the servo light beam LS is transmitted through the substrate 202 and is reflected by the servo layer 204, whereby the direction of polarization of the servo light beam LS is reversed (i.e., into left-handed circular polarization). The resulting servo reflected light beam LSr travels in the opposite direction to the servo light beam LS.

Subsequently, the servo reflected light beam LSr is transmitted through the objective lens 46 and is incident on the quarter-wave plate 45. The quarter-wave plate 45 converts the servo reflected light beam LSr of circular polarization into S polarization, and makes it incident on the dichroic mirror 44.

The dichroic mirror 44 reflects almost 100% of the servo reflected light beam LSr of S polarization, whereby this servo reflected light beam LSr is deflected 90° in the traveling direction and is incident on a condenser lens 48.

The condenser lens 48 converges the servo reflected light beam LSr with an additional astigmatic aberration, and irradiates a photodetector 49 with this servo reflected light beam LSr.

Now, in the optical disc apparatus 20X, the optical disc 200 can cause wobbling and the like during rotation. There is thus a possibility that the target track can vary in relative position with respect to the servo optical system 40.

In order for the servo optical system 40 to make the focal point FS of the servo light beam LS (FIG. 14B) follow the target track, it is necessary to move the focal point FS in focus directions and radial directions of the optical disc 200. The focus directions refer to the directions toward and away from the optical disc 200. The radial directions refer to the directions radially inward or radially outward of the optical disc 200. Of the focus directions, one toward where the first surface 200A is as seen from the center of the optical disc 200 will be referred to as a first surface side. One toward where the second surface 200B is will be referred to as a second surface side.

The objective lens 46 can be driven biaxially in the focus directions and radial directions by an actuator 47.

In the servo optical system 40 (FIG. 19), various optical components are adjusted in optical position so that the state of focusing when the servo layer 204 of the optical disc 200 is irradiated with the servo light beam LS that is collected by the objective lens 46 is reflected on the state of focusing when the photodetector 49 is irradiated with the servo reflected light beam LSr that is collected by the condenser lens 48.

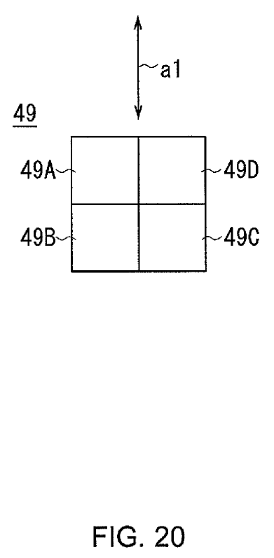

As shown in FIG. 20, the photodetector 49 has four detection areas 49A, 49B, 49C and 49D which are divided in a lattice pattern on the surface irradiated with the servo reflected light beam LSr. Note that the directions shown by the arrow a1 (vertical directions in the diagram) correspond to the running direction of the track when the servo layer 204 (FIG. 14B) is irradiated with the servo light beam LS.

The photodetector 49 detects portions of the servo reflected light beam LSr from the respective detection areas 49A, 49B, 49C, and 49D. According to the amounts of light detected here, the photodetector 49 generates respective detection signals SDs (SDAs, SDBs, SDCs, and SDDs), and transmits these to the signal processing unit 23 (FIG. 8).

The signal processing unit 23 performs tracking control by a so-called push pull method. The signal processing unit 23 calculates a tracking error signal STEs according to the following equation (1), and supplies this signal to the drive control unit 22:

STEs=(SDAs+SDDs)−(SDBs+SDCs) (1)

This tracking error signal STEs indicates the amount of deviation between the focal point FS of the servo light beam LS and the target track of the servo layer 204 of the optical disc 200 in the radial directions.

The signal processing unit 23 also performs focus control by a so-called astigmatic aberration method. The signal processing unit 23 calculates a focus error signal SFEs according to the following equation (2), and supplies this signal to the drive control unit 22:

SFEs=(SDAs+SDCs)−(SDBs+SDDs) (2)

The focus error signal SFEs indicates the amount of deviation between the focal point FS of the servo light beam LS and the servo layer 204 of the optical disc 200 in the focus directions.

The drive control unit 22 generates a tracking drive signal STDs based on the tracking error signal STEs, and supplies the tracking drive signal STDs to the actuator 47.

The drive control unit 22 thereby performs feedback control (i.e., tracking control) on the thread motor 25 and the objective lens 46 so that the servo light beam LS focuses on the target track in the servo layer 104 of the optical disc 200.

The drive control unit 22 also generates a focus drive signal SFDs based on the focus error signal SFEs, and supplies the focus drive signal SFDs to the actuator 47. The drive control unit 22 thereby performs feedback control (i.e., focus control) on the objective lens 46 so that the servo light beam LS focuses on the servo layer 204 of the optical disc 200.

As described above, the servo optical system 40 irradiates the servo layer 204 of the optical disc 200 with the servo light beam LS, and supplies the result of reception of the reflected light, or servo reflected light beam LSr, to the drive control unit 22 through the signal processing unit 23. In response, the drive control unit 22 performs focus control and tracking control on the objective lens 46 so that the servo light beam LS focuses on the target track of the servo layer 204.

### (2-3-2) Irradiation of Light Beam in Information Recording Processing

The optical pickup 39 (FIG. 18) separates a light beam LZ emitted from a laser diode 51 into the recording light beam LC and the reference light beam LA. The optical pickup 39 then irradiates the optical disc 200 with the recording light beam LC from the side of the first surface 200A through the first surface information optical system 50. The optical pickup 39 also irradiates the optical disc 200 with a diffracted light beam LB, which results from the reference light beam LA, from the side of the second surface 200B through the second surface information optical system 70.

The laser diode 51 of the first surface information optical system 50 can launch blue laser light of approximately 405 nm in wavelength. In fact, the laser diode 51 emits the light beam LZ of divergent light based on the control of the control unit 21 (FIG. 8) so that it is incident on a collimator lens 52. The collimator lens 52 converts the light beam LZ from divergent light to parallel light and makes it incident on a polarizing beam splitter 53.

The polarizing beam splitter 53 transmits or reflects a light beam through/at a reflecting/transmitting surface 53S thereof depending on the direction of polarization of the light beam. When the light beam LZ is incident thereon, the polarization beam splitter 53 therefore reflects the light beam LZ which is S-polarized, whereby its traveling direction is deflected 90°, and is incident on a shutter 71 as the reference light beam LA.

In the meantime, the beam splitter 53 transmits the light beam LZ which is P-polarized and makes it incident on a mirror 54 as the recording light beam LC. Note that the ratio between the P-polarized light beam LZ and the S-polarized light beam LZ emitted from the laser diode 51 is determined so that the light intensity of the diffracted light beam LB resulting from the reference light beam LA when irradiating the target mark position is the same as the light intensity of the recording light beam LC when irradiating the target mark position.

### (2-3-2-1) Optical Path of Recording Light Beam LC

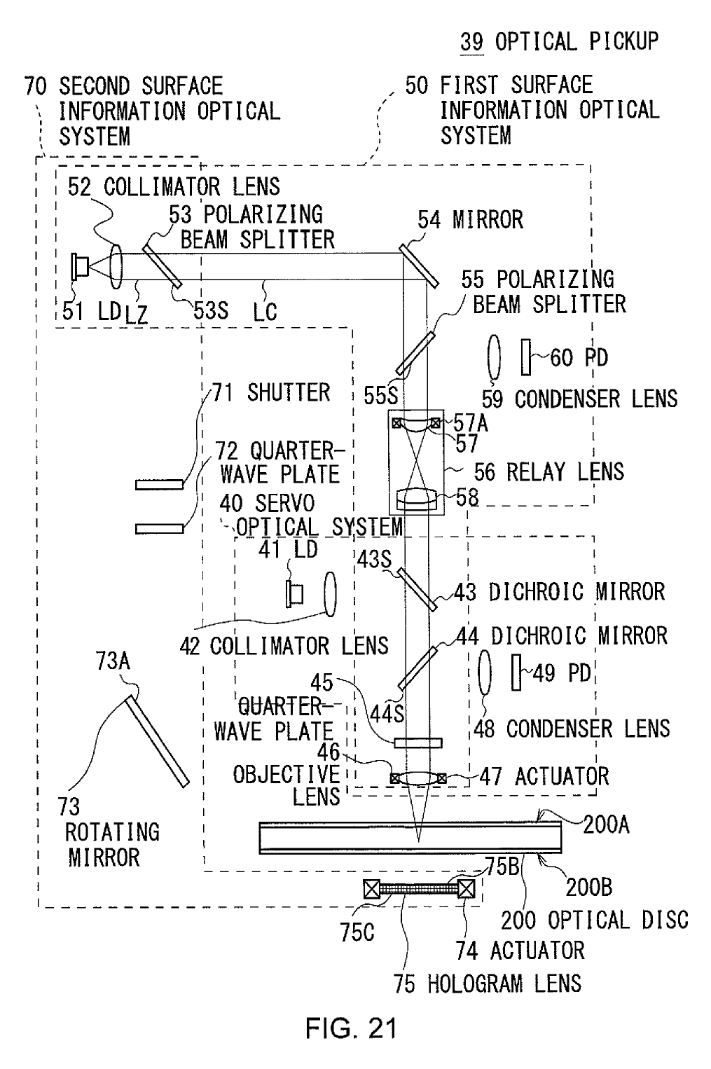

As shown in FIG. 21, the mirror 54 of the first surface information optical system 50 reflects the recording light beam LC, whereby the recording light beam LC is deflected 90° in the traveling direction and is incident on an polarizing beam splitter 55.

The polarizing beam splitter 55 transmits or reflects a light beam through/at a reflecting/transmitting surface 55s thereof depending on the direction of polarization of the light beam. When the recording light beam LC of P polarization is incident thereon, the polarizing beam splitter 55 therefore transmits this recording light beam so that it is incident on a relay lens 56.

The relay lens 56 converts the recording light beam LC from parallel light into convergent light through a movable lens 57, converts the recording light beam LC that is diverting after convergence into convergent light again through a fixed lens 58, and makes it incident on the dichroic mirror 43.

Here, the movable lens 57 is moved in the direction of the optical axis of the recording light beam LC by an actuator 57A. In fact, the relay lens 56 can move the movable lens 57 by using the actuator 57A based on the control of the control unit 21 (FIG. 8), thereby changing the state of convergence of the recording light beam LC to be emitted from the fixed lens 58.

The dichroic mirror 43 transmits the recording light beam LC through the reflecting/transmitting surface 43S according to the wavelength of the recording light beam LC, so that this recording light beam LC is incident on the dichroic mirror 44. The dichroic mirror 44 also transmits the recording light beam LC through the reflecting/transmitting surface 44S according to the wavelength of the recording light beam LC, so that the recording light beam LC is incident on the quarter-wave plate 45. The quarter-wave plate 45 converts the recording light beam LC of P polarization into circular polarization (for example, right-handed circular polarization), and makes it incident on the objective lens 46.

The objective lens 46 collects the recording light beam LC and irradiates the first surface 200A of the optical disc 200 with it. Incidentally, the objective lens 46 functions as a condenser lens having a numerical aperture (NA) of, e.g., 0.5 to the recording light beam LC because of such factors as the optical distance to the relay lens 56.

Here, as shown in FIG. 14B, the recording light beam LC is transmitted through the substrate 202 and the servo layer 204, and is focused inside the stereoscopic mark recording layer 201. Here, the position of the focal point FC of the recording light beam LC is determined by the state of convergence when emitted from the fixed lens 58 of the relay lens 56. That is, the focal point FC moves toward the first surface 200A or the second surface 200B in the stereoscopic mark recording layer 201 according to the position of the movable lens 57.

In fact, in the first surface information optical system 50, the position of the movable lens 57 is controlled by the control unit 21 (FIG. 8) so as to adjust the depth dl of the focal point FC (FIG. 14B) of the recording light beam LC (i.e., the distance from the servo layer 204) in the stereoscopic mark recording layer 201 of the optical disc 200.

The recording light beam LC converges to the focal point FC and becomes divergent light. The resulting recording light beam LC is transmitted through the stereoscopic mark recording layer 201 and the substrate 203, emitted from the second surface 200B, and simply transmitted through the hologram lens 75.

As described above, the first surface information optical system 50 irradiates the optical disc 200 with the recording light beam LC from the side of the first surface 200A so that the focal point FC of the recording light beam LC is positioned inside the stereoscopic recording mark 201. The first surface information optical system 50 also adjusts the depth dl of this focal point FC according to the position of the movable lens 57 in the relay lens 56.

### (2-3-2-2) Irradiation of Diffracted Light Beam

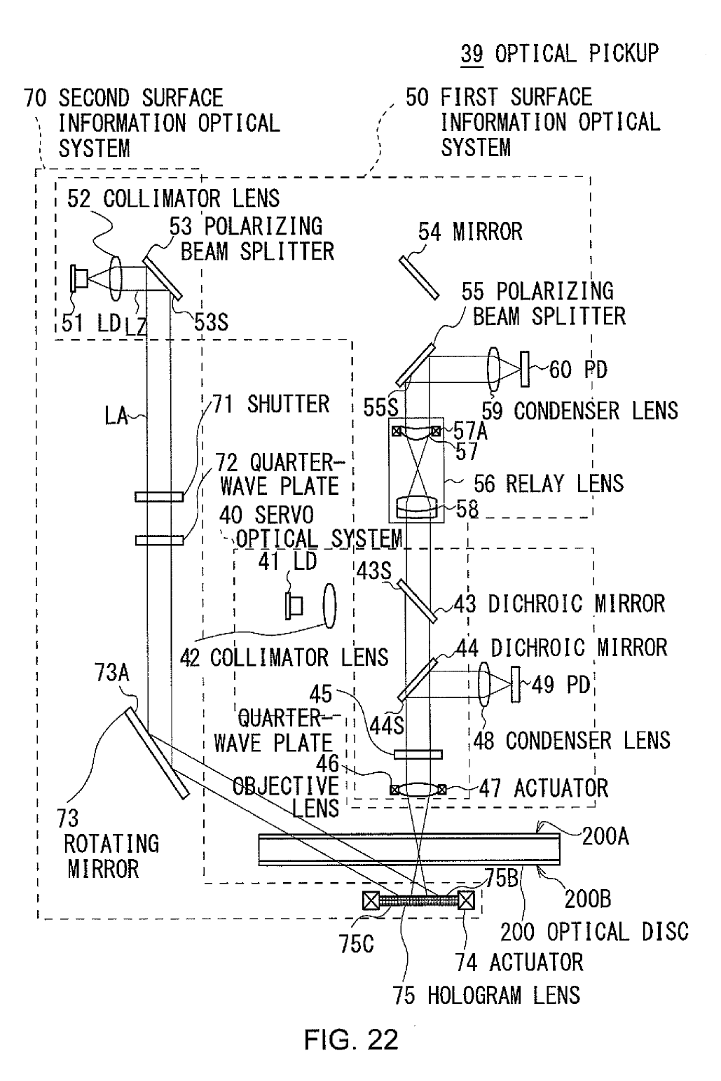

In the meantime, as shown in FIG. 22, the polarizing beam splitter 53 reflects approximately 50% of S-polarized light beam LZ at the reflecting/transmitting surface 53S as mentioned above so that it is incident on the shutter 71 as the reference light beam LA.

The shutter 71 blocks or transmits the reference light beam LA based on the control of the control unit 21 (FIG. 8). The shutter 71 makes the reference light beam LA incident on a quarter-wave plate 72.

The quarter-wave plate 72 converts the reference light beam LA of S polarization into left-handed circular polarization, for example, and makes it incident on a rotating mirror 73. The rotating mirror 73 reflects the reference light beam LA and converts the direction of polarization of this reference light beam LA into the reverse direction (for example, right-handed circuit polarization), and makes it incident on the hologram lens 75 through the optical disc 200.

The rotating mirror 73 is capable of changing the angle of its reflecting surface 73A. Based on the control of the control unit 21, the reflecting surface angle of the reflecting surface 73A is adjusted to an angle φ corresponding to the target depth, so that the reference light beam LA can be incident on the hologram lens 75 at an angle of incidence of θ corresponding to the target depth.

That is, the control unit 21 controls the rotating mirror 73 and thereby adjusts the reflecting surface angle to almost the same angle φ as is the case of manufacturing the hologram lens 75, according to the target depth.

The hologram lens 75 then produces a diffracted light beam LB having a focal length DK corresponding to the angle of incidence of the reference light beam LA incident thereon, and irradiates the second surface 200B of the optical disc 200 with the diffracted light beam LB. Here, as shown in FIG. 14B, the diffracted light beam LB is transmitted through the substrate 203 and is focused inside the stereoscopic mark recording layer 201.

Like the objective lens 46, the hologram lens 75 can be driven by an actuator 74 biaxially, including focus directions which refer to the directions toward and away from the optical disc 200 and radial directions which refer to the directions radially inward or radially outward of the optical disc 200.

In fact, the second surface information optical system 70 drives the hologram lens 75 in the focus directions and the radial directions based on a focus drive signal SFDb and a radial drive signal SRDb, thereby making the focal point FB of the diffracted light beam LB follow the focal point FC of the recording light beam LC.

As a result, the recording light beam LC and the diffracted light beam LB interfere with each other to create a standing wave in the stereoscopic mark recording layer 201, thereby forming a recording mark RM made of a hologram.

As described above, the second surface information optical system 70 irradiates the inside of the stereoscopic mark recording layer 201 with the diffracted light beam LB from the second surface 200B of the optical disc 200 so as to follow the focal point FC of the recording light beam LC with which the target mark point is irradiated. The second surface information optical system 70 thereby forms a recording mark RM at the target mark position in the stereoscopic mark recording layer 201.

For example, when the reference light beam LA of right-handed circular polarization is incident on the hologram lens 75, the hologram lens 75 produces a diffracted light beam LB of left-handed circular polarization due to its characteristics as a hologram.

The diffracted light beam LB converges to the focal point FB and becomes divergent light. The resulting diffracted light beam LB is transmitted through the stereoscopic mark recording layer 201 and the substrate 203, is emitted from the first surface 200A, and is incident on the objective lens 46.

Here, in the first surface information optical system 50, the diffracted light beam LB is somewhat converged through the objective lens 46 before it is incident on the quarter-wave plate 45. The quarter-wavelength plate 45 converts the diffracted light beam LB of left-handed circular polarization into S polarization, and makes it incident on the relay lens 56 through the dichroic mirrors 44 and 43.

The relay lens 56 converts the diffracted light beam LB into generally parallel light and makes it incident on the polarizing beam splitter 55. The polarization beam splitter 55 reflects the diffracted light beam LB of S polarization at the reflecting/transmitting surface 55S so that it is incident on the condenser lens 59.

The condenser lens 59 converges the diffracted light beam LB with an additional astigmatic aberration, and irradiates the photodetector 60 with this diffracted light beam LB.

As described above, in the information recording processing, the first surface information optical system 50 irradiates the optical disc 200 with the recording light beam LC from the side of the first surface 200A so that the focal point FC of the recording light beam LC is positioned inside the stereoscopic recording mark layer 201. The first surface information optical system 50 also adjusts the depth dl of this focal point FC according to the position of the movable lens 57 in the relay lens 56.

The second surface information optical system 70 makes the reference light beam LA pass through the optical disc 200 and irradiates the hologram lens 75 with this reference light beam LA, thereby irradiating the optical disc 200 with the diffracted light beam LB.

This diffracted light beam LB then enters the first surface information optical system 50 through the optical disc 200, and travels along the optical path of this first surface information optical system 50 until it is received by the photodetector 60.

### (2-3-3) Control on Hologram Lens

Now, the optical disc 200 actually has the possibilities of wobbling and the like, and the target mark position can move inside the stereoscopic mark recording layer 201 according to the wobbling and the like. As described above, the hologram lens 75 is thus subjected to focus control and tracking control by the servo optical system 40, the drive control unit 22 (FIG. 8), etc.

Since the focal point FC of the recording light beam LC moves with the movement of the objective lens 46, the focal point FC deviates from the position of the focal point FB of the diffracted light beam LB when the hologram lens 75 is in its reference position.

Then, the optical disc apparatus 20X drives the hologram lens 75 during the information recording processing so that the focal point FB of the diffracted light beam LB follows the focal point FC of the recording light beam LC with which the target mark position is irradiated.

In the first surface information optical system 50, various optical components are adjusted in optical position so that the amount of deviation of the focal point FB of the diffracted light beam LB with respect to the focal point FC of the recording light beam LC in the stereoscopic mark recording layer 201 is reflected on the state of irradiation of the photodetector 60 with the diffracted light beam LB that is collected by the condenser lens 59.

The photodetector 60 generates detection signals corresponding to the respective amounts of light detected, and transmits these signals to the signal processing unit 23 (FIG. 8).

The signal processing unit 23 calculates a focus error signal SFEb by the so-called astigmatic aberration method, and supplies this signal to the drive control unit 22. The focus error signal SFEb indicates the amount of deviation between the focal point FC of the recording light beam LC and the focal point FB of the diffracted light beam LB in the focus directions.

The signal processing unit 23 also calculates a tracking error signal STEb based on a push pull signal, and supplies the tracking error signal STEb to the drive control unit 22. The tracking error signal STEb indicates the amount of deviation between the focal point FC of the recording light beam LC and the focal point FB of the diffracted light beam LB in the radial directions.

In response, the drive control unit 22 generates a focus drive signal SFDb based on the focus error signal SFEb, and supplies this focus drive signal SFDb to the actuator 74. The drive control unit 22 thereby performs focus control on the hologram lens 75 so as to reduce the amount of deviation of the focal point FB of the diffracted light beam LB with respect to the focal point FC of the recording light beam LC in the focus directions.

The drive control unit 22 also generates a tracking drive signal STDb based on the tracking error signal STEb, and supplies the tracking drive signal STDb to the actuator 74. The drive control unit 22 thereby performs tracking control on the hologram lens 75 so as to reduce the amount of deviation of the focal point FB of the diffracted light beam LB with respect to the focal point FC of the recording light beam LC in the radial directions.

As described above, the first surface information optical system 50 receives the diffracted light beam LB that is incident on the objective lens 46 from the first surface 200A of the optical disc 200, and supplies the result of light reception to the drive control unit 22 through the signal processing unit 23. In response, the drive control unit 22 performs focus control and tracking control on the hologram lens 75 so as to adjust the focal point FB of the diffracted light beam LB to the focal point FC of the recording light beam LC.

### (2-3-4) Irradiation of Reproducing Light Beam in Information Reproduction Processing

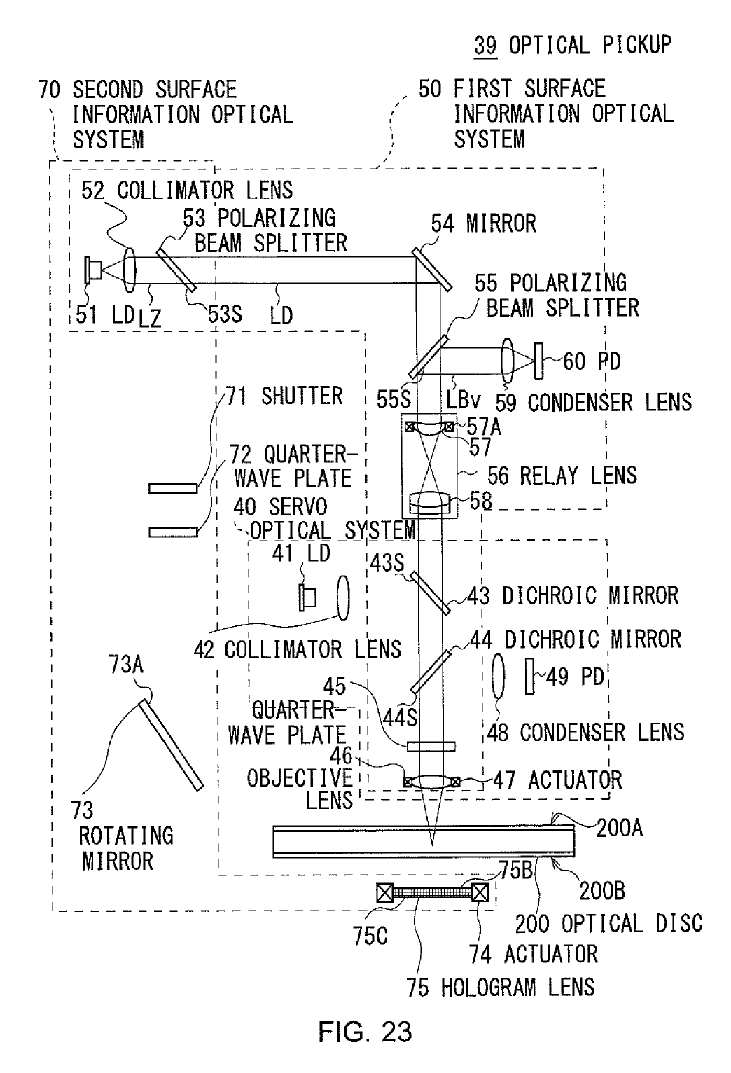

In information reproduction processing, as shown in FIG. 23, the optical pickup 39 emits a reproducing light beam LD of 405 nm from the laser diode 51 under the control of the control unit 21 (FIG. 8).

As with the recording light beam LC, the optical pickup 39 irradiates the optical disc 200 with the reproducing light beam LD through the collimator lens 52, the polarizing beam splitter 53, the mirror 54, the polarizing beam splitter 55, the relay lens 56, the dichroic mirrors 43 and 44, the quarter-wave plate 45, and the objective lens 46.

Here, if the optical disc 200 has a recording mark RM recorded on the stereoscopic mark recording layer 201, the recording mark RM produces a reproduced diffracted light beam LBv due to its properties as a hologram when the focal point FC of the reproducing light beam LD is focused on this recording mark RM as described above.

According to the principles of a hologram, this reproduced diffracted light beam LBv reproduces the light beam with which the recording mark RM is irradiated along with the recording light beam LC at the time of recording, i.e., the diffracted light beam LB.

In the first surface information optical system 50, as shown in FIG. 23, the reproduced diffracted light beam LBv is thus converted into generally parallel light through the objective lens 46 and then converted into S polarization through the quarter-wave plate 45. The reproduced diffracted light beam LBv is further transmitted through the dichroic mirrors 44 and 43, is converted into parallel light through the movable lens 57 and the fixed lens 58 of the relay lens 56, and is incident on the polarizing beam splitter 55.

The polarizing beam splitter 55 reflects the reproduced diffracted light beam LBv of S polarization according to the direction of polarization so that it is incident on the condenser lens 59. The condenser lens 59 collects the reproduced diffracted light beam LBv and irradiates the photodetector 60 with it.

Incidentally, the optical components of the first surface information optical system 50 are arranged so that the reproduced diffracted light beam LBv focuses on the photodetector 60.

The photodetector 60 detects the amount of the reproduced diffracted light beam LBv, generates a reproduction detection signal SDp according to the amount of light detected here, and supplies this signal to the signal processing unit 23 (FIG. 8).

The reproduction detection signal SDp shows the information recorded on the optical disc 200. The signal processing unit 23 then applies predetermined demodulation processing, decoding processing, and the like to the reproduction detection signal SDp to generate reproduction information, and supplies the reproduction information to the control unit 21.

During the information reproducing processing, the optical pickup 39 operates the shutter 71 to block the reference light beam LA, thereby preventing the second surface information optical system 70 from producing the diffracted light beam LB.

As described above, in the information reproduction processing, the first surface information optical system 50 receives the reproduced diffracted light beam LBv which is incident on the objective lens 46 from the first surface 200A of the optical disc 200, and supplies the result of light reception to the signal processing unit 23.

### (2-3-5) Thinning of Optical Pickup

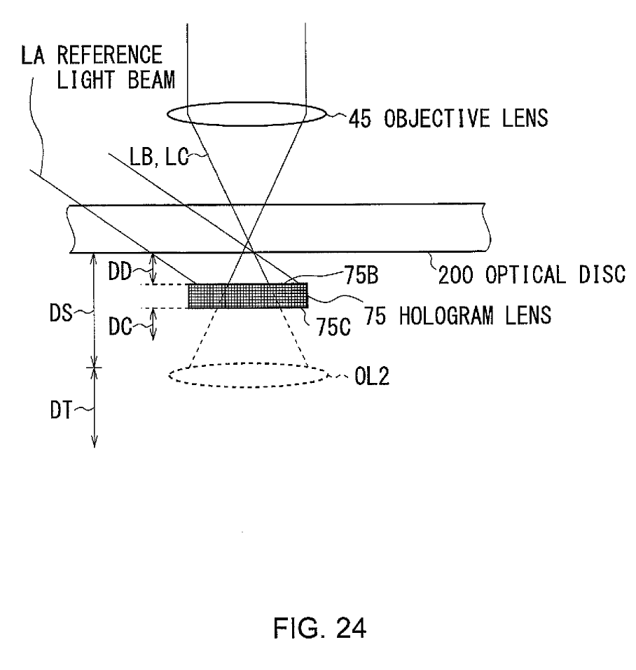

As shown by the broken lines in FIG. 24, a conventional optical disc apparatus using two objective lenses irradiates the second surface 200B with a light beam through an objective lens OL2. The conventional optical disc apparatuses therefore requires that a distance DS be secured from the objective lens OL2 to the second surface 200B according to the focal length DX for collecting a light beam of parallel light.

In order to displace the objective lens OL2 depending on the focal position (target mark position) and to displace the objective lens OL2 in response to wobbling and the like of the optical disc 200, the conventional optical disc apparatus also requires a relatively large distance DT to be secured from the objective lens OL2. That is, a large working distance WD is necessary. The conventional optical disc apparatus further requires the provision of optical components for making the light beam incident on the objective lens OL2 perpendicularly, such as a rising prism. It is therefore necessary to provide some thickness for the configuration on the side of the second surface 200B.

Meanwhile, in the optical pickup 39, the hologram lens 75 is located a distance DD away from the surface of the optical disc (i.e., the second surface 200B) as described above. That is, as shown by the full lines in FIG. 24, the hologram lens 75 has only to reproduce the top portion of the condensed light beam. This can reduces the focal length DK from the hologram lens 75 to the focal point FB, making the distance DD relatively small.

Moreover, in the optical pickup 39, the reference light beam LA is transmitted through the optical disc 200 before the reference light beam LA is incident on the hologram lens 75. This requires only that the optical pickup 39 irradiate the opposed surface 75B opposed to the optical disc 200 with the reference light beam LA. No optical component therefore needs to be arranged on the side of the second surface 200B other than the hologram lens 75 and the actuator 74 which drives the hologram lens 75.

This hologram lens 75 is displaced in the focus directions by the actuator 74 in response to wobbling of the optical disc 200, so that the same distance DD is maintained between the second surface 200B and the hologram lens 75 with little change. That is, since the optical pickup 39 can produce diffracted light beams LB with different focal lengths DK, it is not necessary to displace the hologram lens 75 depending on the target mark position nor secure the space accordingly.

Consequently, aside from the thickness of the hologram lens 75 itself and the distance DD, the optical pickup 39 only requires a gap DC on the side of the second surface 200B where the hologram lens 75 can be displaced to the side of the backside 75C according to wobbling and the like of the optical disc 200. The optical pickup 39 thus allows a significant reduction in thickness on the side of the second surface 200B as compared to the conventional optical disc apparatus using the objective lens OL2.

### (2-4) Operation and Effect

With the foregoing configuration, the hologram lens manufacturing apparatus 1X irradiates the hologram recording element 75a with the reference light beam L1 from the opposed surface 75B which is opposite to the backside 75C where the irradiation light beam L2 is incident on.

The hologram lens 75 can thus produce a diffracted light beam LB when the emission surface 75C is irradiated with the reference light beam LA having the same properties as those of the reference light beam L1.

Here, the hologram lens manufacturing apparatus 1X irradiates the hologram recording element 75a with the reference light beam L1 that is transmitted through the optical disc 200.

The hologram lens 75 can thus produce the diffracted light beam LB in response to the reference light beam LA that has the same properties as those of the reference light beam L1 with a spherical aberration occurring during transmission through the optical disc 200.

The optical pickup 39 separates the light beam emitted from the laser diode 51 into the recording light beam LC and the reference light beam LA, and irradiates the same target mark position of the optical disc 200 with the recording light beam LC and the reference light beam LA from the first surface 200A and the second surface 200B, respectively.

Here, the optical pickup 39 can simply make the reference light beam LA pass through the optical disc 200 and irradiate the emission surface 75C of the hologram lens 75 arranged on the side of the second surface 200B with the reference light beam LA.

That is, the hologram lens 75 can emit the diffracted light beam LB to the side of the emission surface 75C backward in response to the reference light beam LA which is incident on the emission surface 75C. This eliminates the need to provide any optical component on the side of the backside 75C in the optical pickup 39.

Since no component is required to be provided on the side of the second surface 200B of the optical disc 200 except the hologram lens 75 and the actuator 74 for driving the hologram lens 75, the optical pickup 39 can be made low profile on the side of the second surface 200B.

The hologram lens 75 has only to reproduce the top portion of the irradiation light beam L2. This makes it possible to reduce the distance DD from the disc surface to the hologram lens 75.

The hologram lens 75 can produce the diffracted light beam LB that has a spherical aberration assumed to occur inside the optical disc 200. This makes it possible to reduce the spot size at the focal point FB of the diffracted light beam LB.

Consequently, even if the recording light beam LC undergoes a spherical aberration and the spot size of this recording light beam LC increases, the optical pickup 39 can form a recording mark RM of relatively small diameter only in the area where the recording light beam LC and the diffracted light beam LB overlap with each other. As a result, the optical pickup 39 can effectively suppress variations in the size of the recording mark RM depending on the target mark position.

According to the foregoing configuration, the hologram lens manufacturing apparatus 1X projects the reference light beam L1 onto the opposed surface 75B which is opposite to the backside 75C where the irradiation light beam L2 is incident on. The hologram lens 75 can thus emit the diffracted light beam LB from the emission surface 75C when the opposed surface 75B is irradiated with the reference light beam LA that has the same properties as those of the reference light beam L1.

For example, the hologram lens 75 is used for the optical pickup 39 which separates the light beam emitted from the laser diode 51 into the reference light beam LA and the recording light beam LC once, and makes the reference light beam LA and the recording light beam LC overlap with each other in the optical disc 200 from respective opposite directions to form a recording mark RM as a hologram.

In this case, the optical pickup 39 can irradiate the hologram lens 75 arranged on the side of the second surface 200B with the reference light beam LA produced by separation on the side of the first surface 200A, from the side of this first surface 200A. Since the optical pickup 39 can simply irradiate the emission surface 75C of the hologram lens 75 opposite to the second surface 200B with the reference light beam LA, it is unnecessary to route the optical path of the reference light beam LA to the backside 75C of the hologram lens 75. This allows simplified configuration on the side of the second surface 200B.

### (2-5) Other Embodiments

The foregoing second embodiment has dealt with the case where a recording mark RM made of a hologram is formed by an interference pattern occurring between two overlapping light beams. However, the present invention is not limited thereto. For example, on a recording medium with preformed holograms, recording marks may be formed by collapsing the holograms. Recording marks may be made of pores. In these cases, the optical pickup may have the same configuration as in the first embodiment. The hologram lens may be arranged on the side of the second surface 200B of the optical disc 200 with respect to the other optical components so that the hologram lens 75 is irradiated with the reference light beam LA that is transmitted through the optical disc 200 as in the present embodiment.

The foregoing second embodiment has also dealt with the case where the optical disc 200 is irradiated with the recording light beam LC through the objective lens 46. The present invention is not limited thereto, however, and may use a hologram lens HL instead of the objective lens 46. For example, the optical components of the first surface information optical system are arranged as in the first embodiment, and the hologram lens HL is opposed to the first surface 200A.

The foregoing second embodiment has also dealt with the case where the target mark position in the optical disc 200 is determined with reference to the servo layer 204. However, the present invention is not limited thereto. For example, the target mark position may be determined with reference to a surface of the optical disc 200 (i.e., the first surface 200A or the second surface 200B), or based on the absolute position of the optical disc 200.

The foregoing second embodiment has also dealt with the case where the state of convergence of the recording light beam LC incident on the objective lens 46 is changed to move the position of the focal point FC of the recording light beam LC in the focus directions away from and toward the optical disc 200. However, the present invention is not limited thereto. For example, the objective lens 46 may be moved in the focus directions.

The foregoing second embodiment has also dealt with the case where the hologram lens 75 and the second surface 200B have a fixed distance DD therebetween. However, the present invention is not limited thereto. For example, the optical disc 200 may be irradiated with the diffracted light beam LB from different distances DD. In this case, for example, the optical pickup may include a hologram lens that contains a plurality of holograms GM with different aberrations and the same focal length DK so that the focal position can be moved by displacing the hologram lens in the focus directions.

### (3) Third Embodiment

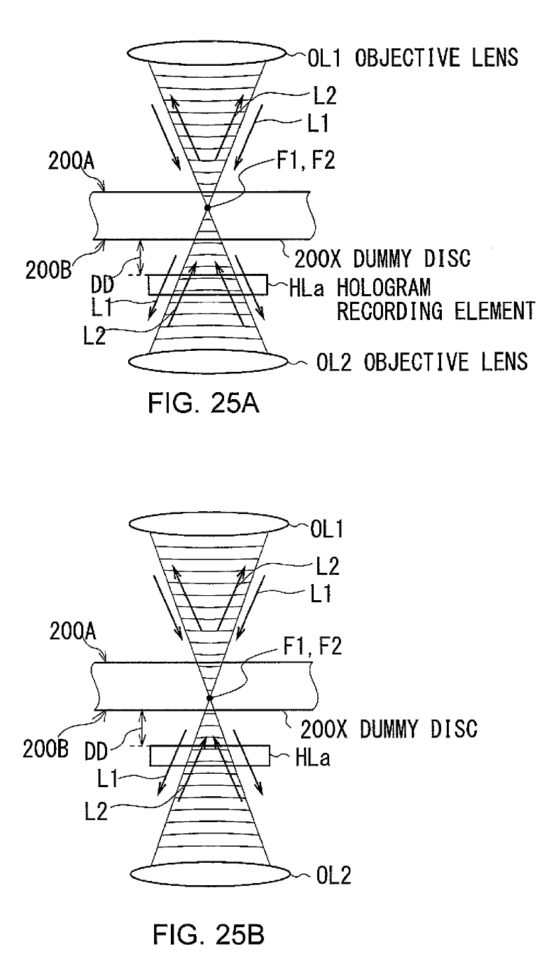

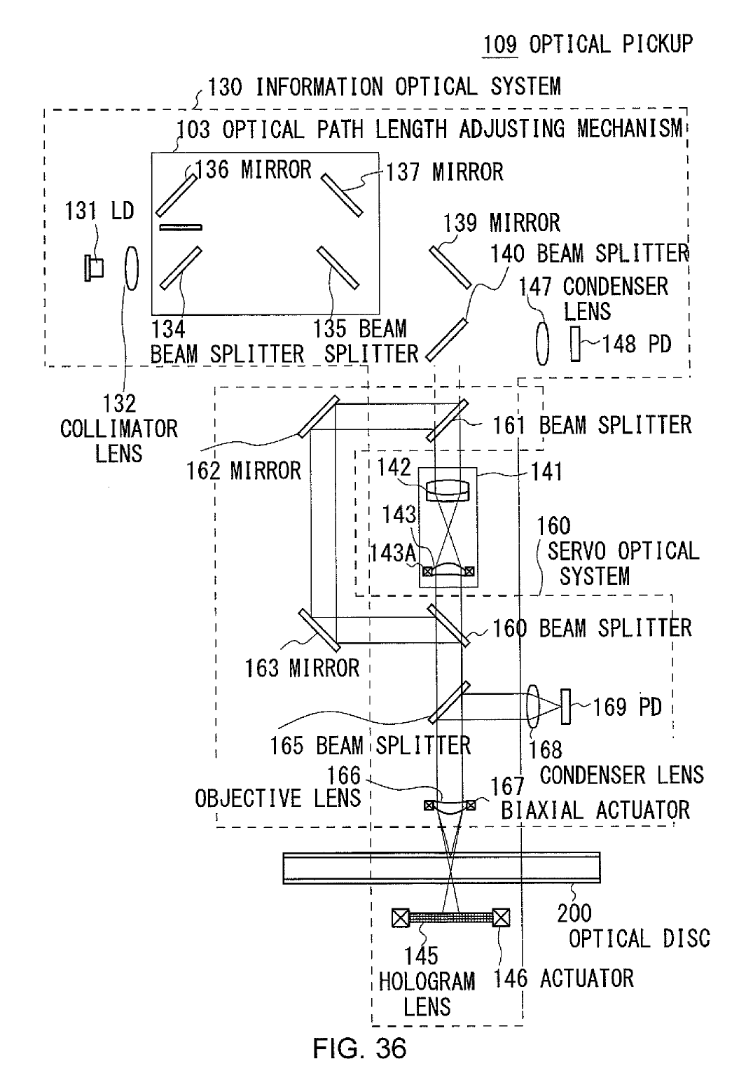

FIGS. 25A to 36 show a third embodiment. Parts corresponding to those of the second embodiment shown in FIGS. 13A to 24 will be designated by like reference numerals. Since the configuration of an optical disc apparatus 20Y is the same as in the second embodiment, description thereof will be omitted.

In the third embodiment, a hologram lens manufacturing apparatus 81 uses a dummy disc 200X having the same characteristics as those of the optical disc 200 instead of the optical disc 200. The hologram lens manufacturing apparatus 81 also uses a light beam that is focused on inside the dummy disc 200X as the reference light beam L1.

More specifically, as shown in FIGS. 25A and 25B, the hologram lens manufacturing apparatus 81 irradiates a target mark position in the dummy disc 200X with the reference light L1 through an objective lens OL1, projecting the reference light beam L1 from the side of a first surface 200A of the dummy disc 200X. Consequently, the reference light beam L1 passes the focal point F1 to become divergent light, which is transmitted through the dummy disc 200X and irradiates a hologram recording element HLa.

The hologram lens manufacturing apparatus 81 also irradiates the target mark position in the dummy disc 200X with a reference light beam L2 through an objective lens OL2, projecting the irradiation light beam L2 from the side of a second surface 200B of the dummy disc 200X. Consequently, the hologram recording element HLa is irradiated with the irradiation light beam L2 as convergent light before reaching the dummy disc 200X.

As a result, in the hologram recording element HLa, the reference light beam L1 of divergent light and the irradiation light beam L2 of convergent light overlap and interfere with each other to create an interference pattern. The hologram recording element HLa can record this interference pattern as a hologram.

It is known that when a light beam is collected by a typical objective lens, the resulting spherical wave varies depending on such factors as the state of collection of the light beam and the distance from the focal point or the objective lens.

As shown in FIGS. 25A and 25B, the hologram lens manufacturing apparatus 81 according to the third embodiment then changes the positions of the focal points F1 and F2, with the second surface 200B of the dummy disc 200X and the hologram recording element HLa at a fixed distance DD. The hologram lens manufacturing apparatus 81 can thus change the states of the spherical waves of the reference light beam L1 and the irradiation light beam L2 in the hologram recording element HLa. The hologram lens manufacturing apparatus 81 thereby records a plurality of holograms GM according to the states of the spherical waves in a multiple fashion, manufacturing a hologram lens HL.

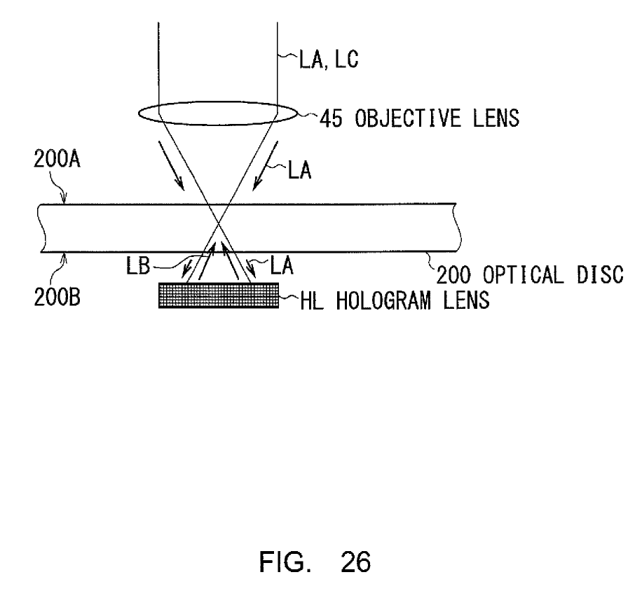

In the third embodiment, as shown in FIG. 26, a reference light beam LA is projected so that the focal point FA of this reference light beam LA coincides with the target mark position. The hologram lens HL is irradiated directly with the reference light beam LA that is transmitted through the optical disc 200. Here, the hologram lens HL produces a diffracted light beam LB that has a focal point FB on the target mark position, and irradiates the target mark position in the optical disc 200 with the diffracted light beam LB. As a result, according to the third embodiment, the reference light beam LA and the diffracted light beam LB can interfere with each other at the target mark point, thereby forming a recording mark RM made of a hologram.

### (3-1) Configuration of Hologram Lens Manufacturing Apparatus

The hologram lens manufacturing apparatus 81 according to the third embodiment does not use the optical disc 200 but the dummy disc 200X. The dummy disc 200X has the same refractive index and thickness as those of the optical disc 200, and makes no variation in the refractive index depending on the irradiation of light beams. This dummy disc 200X has no servo layer 204. Assuming an apparent servo layer (hereinafter, referred to as apparent servo layer 204X) at the same position as in the optical disc 200, the position in the focus direction with respect to the apparent servo layer 204 shall be referred to as depth.

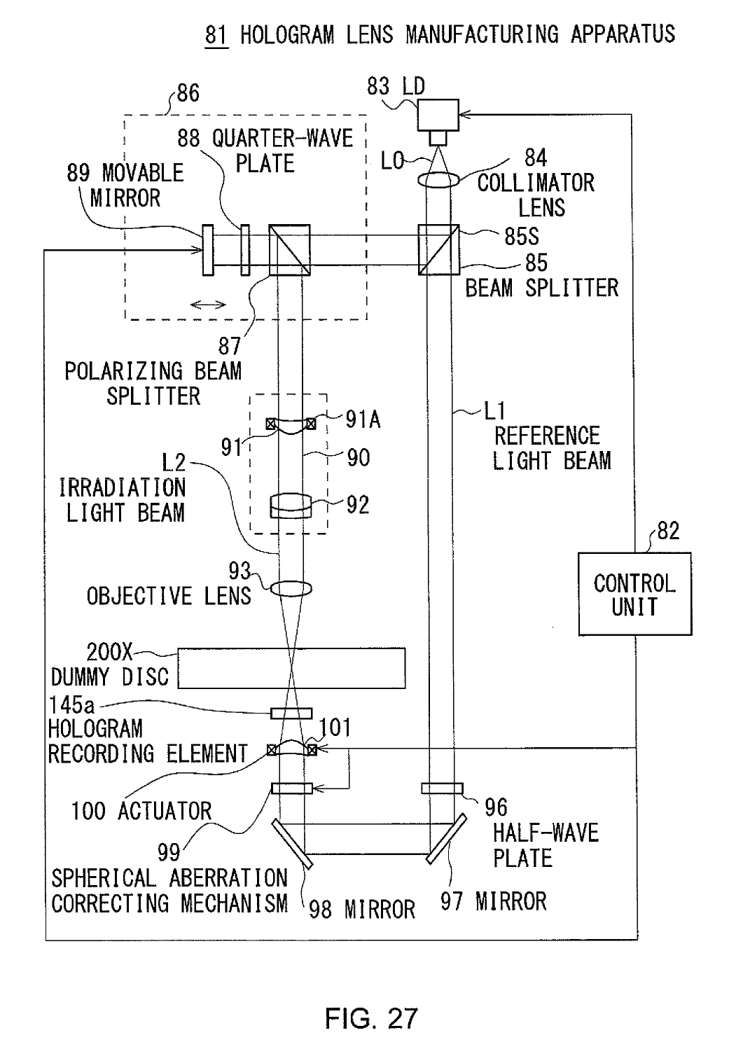

As shown in FIG. 27, the hologram lens manufacturing apparatus 81 has a laser diode 83 made of a semiconductor laser as a light source.

The laser diode 83 emits laser light of relatively short coherence length as a light beam L0 under the control of a control unit 82. For example, the laser diode 83 emits a P-polarized light beam L0 of 405 nm and makes it incident on a collimator lens 84.

The collimator lens 84 converts the light beam L0 of divergent light into parallel light and makes it incident on a beam splitter 85.

The beam splitter 85 transmits or reflects a light beam in predetermined ratios through/at its reflecting/transmitting surface 85S. The beam splitter 85 transmits a part of the light beam L0 as a reference light beam L1, and makes the rest of the light beam L0 incident on an optical path length adjusting mechanism 86 as an irradiation light beam L2.

Since the hologram lens manufacturing apparatus 81 emits the light beam L0 from the laser diode 83 made of a semiconductor layer, the light beam L0 has a short coherent length. The hologram lens manufacturing apparatus 81 therefore adjusts the optical path length of the reference light beam L1 by using the optical path length adjusting mechanism 86 so that the difference between the optical path lengths of the reference light beam L1 and the irradiation light beam L2 will not exceed the coherence length.

When the reference light beam L1 of P polarization is incident thereon, a polarizing beam splitter 87 of the optical path length adjusting mechanism 86 transmits the reference light beam L1 through its reflecting/transmitting surface 87S according to the direction of polarization, so that the reference light beam L1 is incident on a quarter-wave plate 88.

The quarter-wave plate 88 converts the reference light beam L1 of P polarization incident from the polarizing beam splitter 87 into circular polarization (for example, right-handed circular polarization), and irradiates a movable mirror 89 with the reference light beam L1. The reference light beam L1 is reflected by the movable mirror 89 and thereby converted in the direction of polarization into, e.g., left-handed circular polarization. The quarter-wave plate 88 converts this reference light beam L1 into S polarization and makes it incident on the polarizing beam splitter 87 again.

The polarizing beam splitter 87 reflects the incident reference light beam L1 at the reflecting/transmitting surface 87S according to the direction of polarization of this reference light beam L1 (S polarization) so that it is incident on a relay lens 90.

Here, the reflecting surface 89A of the movable mirror 89 is arranged orthogonal to the optical axis of the reference light beam L1. The movable mirror 89 reflects the irradiating reference light beam L1 in the direction of its optical axis Lx, thereby folding back the reference light beam L1 by 180° so that it is incident on the quarter-wave plate 88 again. In consequence, the optical path length adjusting mechanism 86 can extend the optical path length of the reference light beam L1 by means of the polarizing beam splitter 87, the quarter-wave plate 88, and the movable mirror 89.

The relay lens 90 moves a movable lens 91 by using an actuator 91A based on the control of the control unit 82 (FIG. 26), thereby changing the state of convergence of the reference light beam L1 to be emitted from a fixed lens 92.

An objective lens 93 collects the reference light beam L1 and irradiates the dummy disc 200X, which has the same thickness and refractive index as those of the optical disc 200, with the reference light beam L1. Here, the hologram lens manufacturing apparatus 81 drives the actuator 91A to displace the movable lens 91 under the control of the control unit 82, thereby adjusting the focal point F1 of the reference light beam L1 to the target mark position in the dummy disc 200X.

In the meantime, the beam splitter 85 makes the transmitted irradiation light beam L2 incident on a half-wave plate 96. The half-wave plate 96 converts the irradiation light beam L2 of P polarization into S polarization, and makes it incident on a mirror 97.

The mirror 97 deflects the irradiation light beam L2 by 90° in the traveling direction so that it is incident on a mirror 98. The mirror 98 deflects the irradiation light beam L2 by 90° in the traveling direction so that it is incident on a spherical aberration correcting mechanism 99.

The spherical aberration correcting mechanism 99 is composed of a plurality of liquid crystal elements, for example. By the application of an arbitrary voltage under the control of the control unit 82, the spherical aberration correcting mechanism 99 adds a spherical aberration corresponding to the depth of the target mark position (i.e., target depth) to the irradiation light beam L2, and makes this irradiation light beam L2 incident on an objective lens 101.

The objective lens 101 collects the irradiation light beam L2 and irradiates the target mark position in the dummy disc 200X with the irradiation light beam L2. In the hologram lens manufacturing apparatus 81, the same target mark position is thus irradiated with the reference light beam L1 and the irradiation light beam L2 which are collected by the objective lenses 93 and 101.

A hologram recording element 145a is located a distance DD away from the objective lens 101. As shown in FIG. 27, the hologram recording element 145a is simultaneously irradiated with the irradiation light beam L2 that is collected by the objective lens 101 and yet to be transmitted through the dummy lens 200X, and with the reference light beam L1 that is collected by the objective lens 93 and transmitted through the dummy disc 200X.

As a result, an interference pattern occurring between the overlapping spherical waves (convergent light and divergent light) is recorded on the hologram recording element 145a as a hologram.

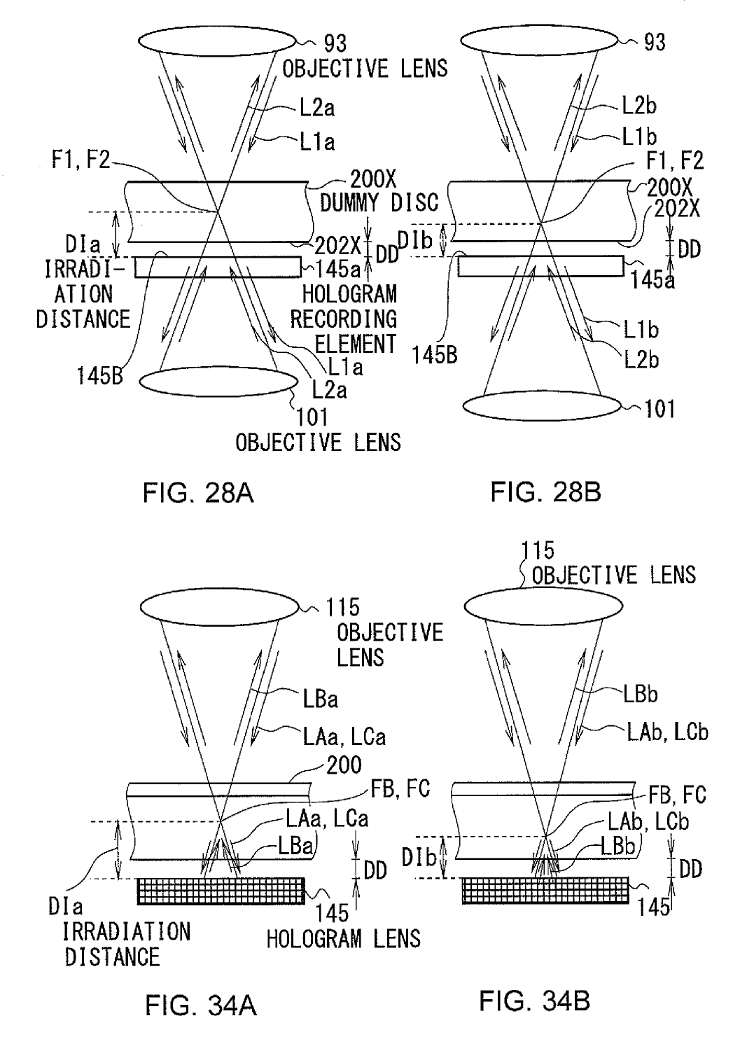

More specifically, in the hologram lens manufacturing apparatus 81, as shown in FIGS. 28A and 28B, the reference light beam L1 having a spherical wave corresponding to the irradiation distance DI (DIa and DIb) from the focal points F1 and F2 to the opposed surface 145B of the hologram recording element 145a and the irradiation light beam L2 corresponding to the irradiation distance DI interfere with each other to form a hologram in the hologram recording element 145a.

For example, as shown in FIG. 28A, the hologram lens manufacturing apparatus 81 forms in the hologram recording element 145a a hologram that results from the interference between the reference light beam L1a and the irradiation light beam L2a having respective spherical waves corresponding to the irradiation distance DIa.

Here, the hologram lens manufacturing apparatus 81 makes the reference light beam L1a pass through the dummy disc 200X before irradiating the hologram recording element 145a with the reference light beam L1a. The hologram recording element 145a is thus irradiated with the reference light beam L1a that is given a spherical aberration that occurs depending on the dummy disc 200X.

The hologram lens manufacturing apparatus 81 can also add a spherical aberration corresponding to the target depth to the irradiation light beam L2a by using the spherical aberration correcting mechanism 99, so that the hologram recording element 145a is irradiated with the irradiation light beam L2a that has near zero spherical aberration at the focal point F2 inside the dummy disc 200X.

Then, the hologram lens manufacturing apparatus 81 adds a spherical aberration corresponding to the next target mark position (i.e., focal position) by using the spherical aberration correcting mechanism 99, and drives the actuators 91A and 100 to displace the movable lens 91 and the objective lens 101 to the next target mark position. As shown in FIG. 28B, a hologram resulting from the interference between the reference light beam L1 and the irradiation light beam L2 having respective spherical waves corresponding to the irradiation distance DIb is thus formed in the hologram recording element 145a.

The hologram lens manufacturing apparatus 81 changes the focal points F1 and F2 and the spherical aberration to be added to the irradiation light beam L2 according to target depths in succession while recording 20 holograms GM corresponding to 20 apparent mark recording layers on the hologram recording element 145a in a multiple fashion, thereby manufacturing a hologram lens 145.

As described above, the hologram lens manufacturing apparatus 81 projects the reference light beam L1 and the irradiation light beam L2 from the opposed objective lenses 93 and 101 so that the focal points F1 and F2 coincide with each other at the same target mark position. The hologram recording element 145a is thereby irradiated with the irradiation light beam L2 that is before focusing and the reference light beam L1 that is after focusing.

As a result, the hologram lens manufacturing apparatus 81 can record an interference pattern resulting from the interference between the reference light beam L1 and the irradiation light beam L2 as a hologram GM on the hologram recording element 145a.

Here, the reference light beam L1 and the irradiation light beam L2 for the hologram recording element 145a to be irradiated with have spherical waves corresponding to the irradiation distance DI from the hologram recording element 145a to the focal points F1 and F2.

The hologram lens manufacturing apparatus 81 then displaces the movable lens 91 and the objective lens 101, thereby changing the positions of the focal points F1 and F2 to target mark positions in the 20 apparent mark recording layers in succession. As a result, the hologram lens manufacturing apparatus 81 can manufacture a hologram lens 145 which is the hologram recording element 145a on which holograms GM are recorded according to the irradiation distances DI corresponding to the 20 apparent mark recording layers.

### (3-2) Configuration of Optical Pickup

Next, description will be given of the configuration of an optical pickup 109.

As schematically shown in FIG. 29, the optical pickup 109 includes a large number of optical components, which are broadly classified into a servo optical system 110 and an information optical system 130.

### (3-2-1) Tracking Control

As with the optical pickup 39 (FIG. 19), the servo optical system 110 irradiates the first surface 200A of the optical disc 200 with a servo light beam LS, and receives a servo reflected light beam LSr which is the servo light beam LS reflected by the optical disc 200.

In FIG. 30, a laser diode 111 of the servo optical system 110 can emit red laser light of approximately 660 nm in wavelength. In fact, the laser diode 111 emits a predetermined amount of servo light beam LS of divergent light based on the control of the control unit 21 (FIG. 8) so that it is incident on a collimator lens 112. The collimator lens 112 converts the servo light beam LS from divergent light into parallel light, and makes it incident on a beam splitter 113.

The beam splitter 113 reflects or transmits a light beam in a predetermined ratio. The beam splitter 113 transmits a part of the servo light beam LS incident thereon so that it is incident on a beam splitter 114.

The beam splitter 114 also reflects or transmits a light beam in a predetermined ratio. The beam splitter 114 transmits a part of the servo light beam LS incident thereon so that it is incident on an objective lens 115.

The objective lens 115 collects the servo light beam LS and projects it toward the first surface 200A of the optical disc 200. Here, as shown in FIG. 14B, the servo light beam LS is transmitted through the substrate 202 and is reflected by the servo layer 204 so that the resulting servo reflected light beam LSr travels in the opposite direction to the servo light beam LS.

Subsequently, the servo reflected light beam LSr is transmitted through the objective lens 115 and is incident on the beam splitter 114. The beam splitter 114 reflects a part of the servo reflected light beam LSr, whereby this servo reflected light beam LSr is deflected 90° in the traveling direction and is incident on a condenser lens 48.

The condenser lens 48 converges the servo reflected light beam LSr with an additional astigmatic aberration, and irradiates a photodetector 49 with the servo reflected light beam LSr.

The photodetector 49 generates detection signals SDs (SDAs, SDBs, SDCs, and SDDs) according to the amounts of light received by respective four detection areas 49A, 49B, 49C, and 49D, and transmits these signals to the signal processing unit 23 (FIG. 8).

In consequence, the optical disc apparatus 20Y performs focus control and tracking control on the objective lens 115 so that the servo light beam LS focuses on a target track of the servo layer 204 as in the second embodiment.

As described above, the servo optical system 110 uses the non-polarizing beam splitters 113 and 114 which transmit and reflect a light beam in predetermined ratios. This eliminates the need for quarter-wave plates, and can simplify the configuration as compared to the optical pickup 39 according to the second embodiment.

### (3-2-2) Irradiation of Light Beam in Information Recording Processing

### (3-2-2-1) Optical Path of Recording Light Beam LC

As mentioned previously, in the optical pickup 109 according to the third embodiment, the reference light beam LA that is focused on the focal point FA in the optical disc 200 is transmitted through the optical disc 200 before the hologram lens HL is irradiated with the reference light beam LA to produce a diffracted light beam LB.

As shown in FIG. 26, the reference light beam LA focused on the focal point FA in the optical disc 200 and the diffracted light beam LB produced by the irradiation of the hologram lens HL past the optical disc 200 have different optical path lengths.

The optical pickup 109 uses a laser diode 131 which is composed of a semiconductor laser of short coherent length as a light source. If the optical pickup simply projects the reference light beam LA, the difference between the optical path lengths can exceed the coherence length, failing to create a standing wave to form a recording mark RM.

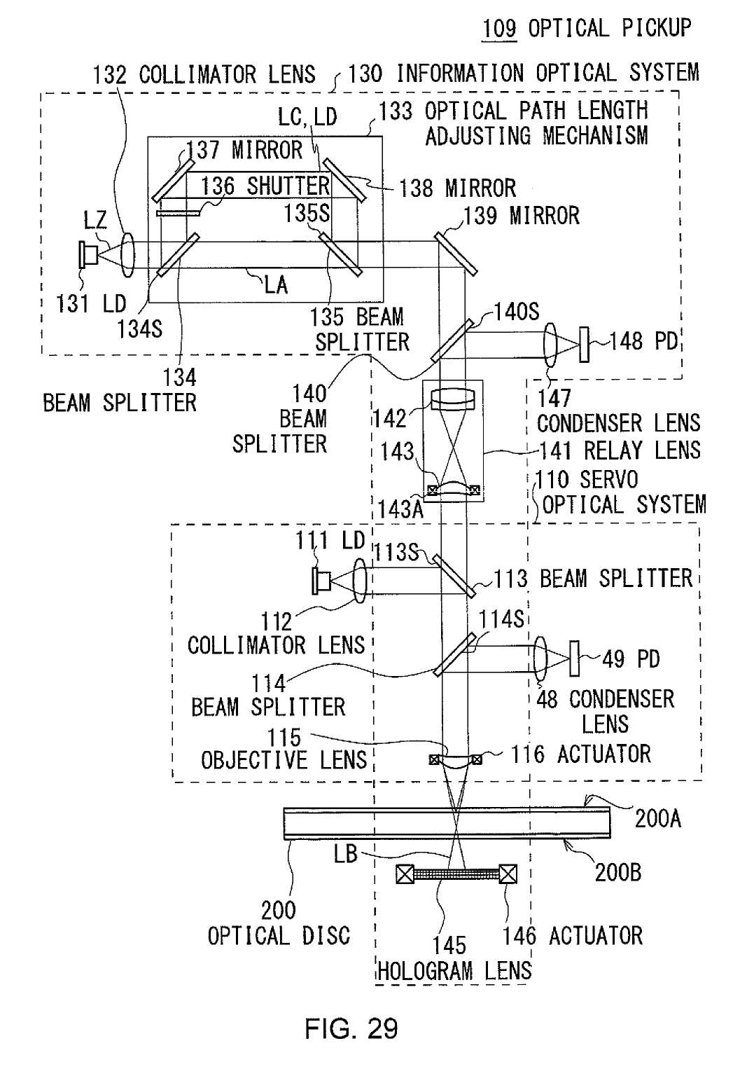

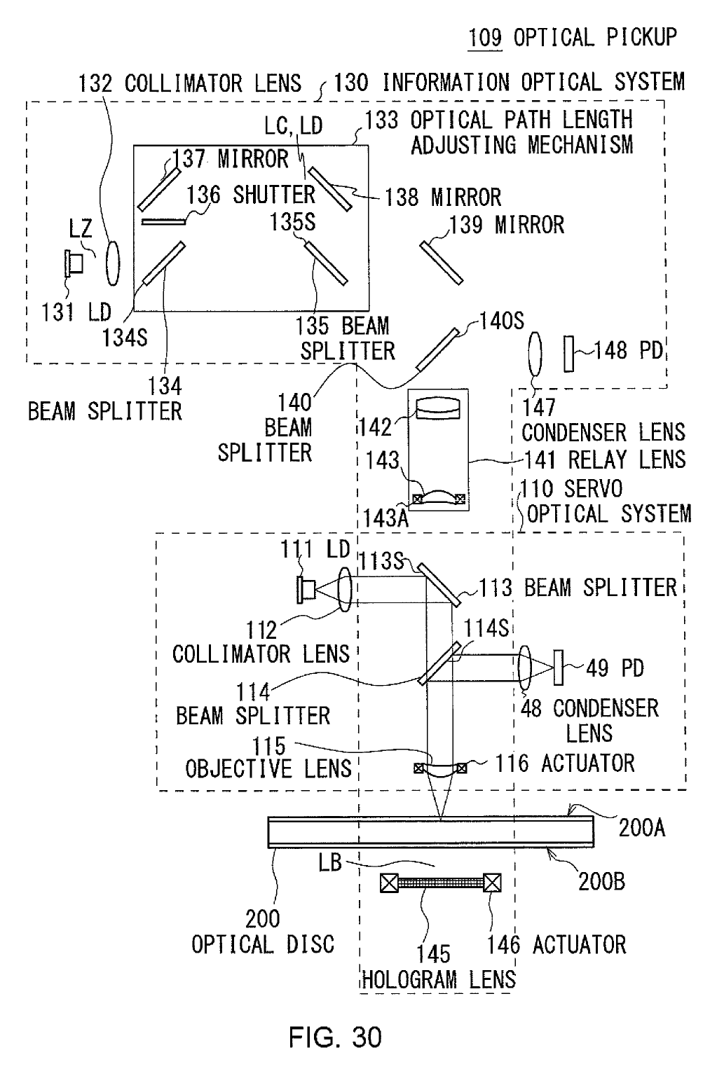

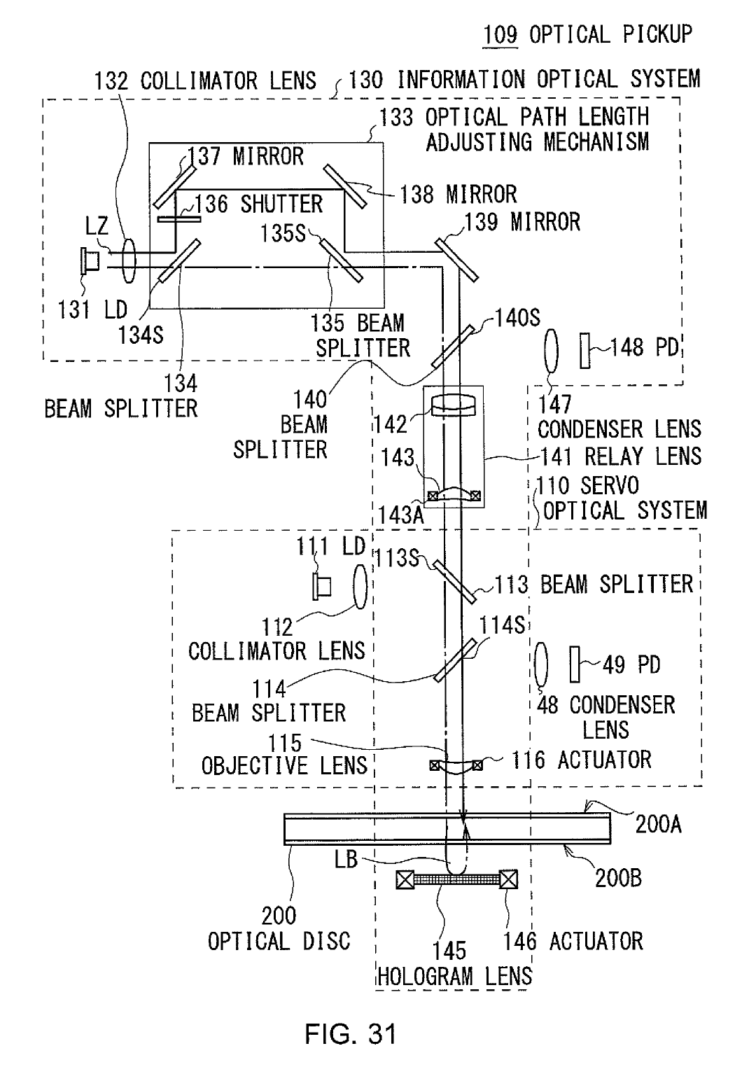

Then, as shown in FIG. 31, the optical pickup 109 separates the light beam emitted from the laser diode 131 into a reference light beam LA (shown in dashed lines) and a recording light beam LC (shown in solid lines). The optical pickup 109 collects the reference light beam LA through the objective lens 115 once, makes it pass through the optical disc 200, and then irradiates the hologram lens 145 with the reference light beam LA. The optical pickup 109 thereby irradiates the target mark position with a diffracted light beam LB from the side of the second surface 200B.

The optical pickup 109 also collects the recording light beam LC that is passed an optical path longer than that of the reference light beam LA with the objective lens 115, and irradiates the target mark position with the recording light beam LC from the side of the first side 200A.

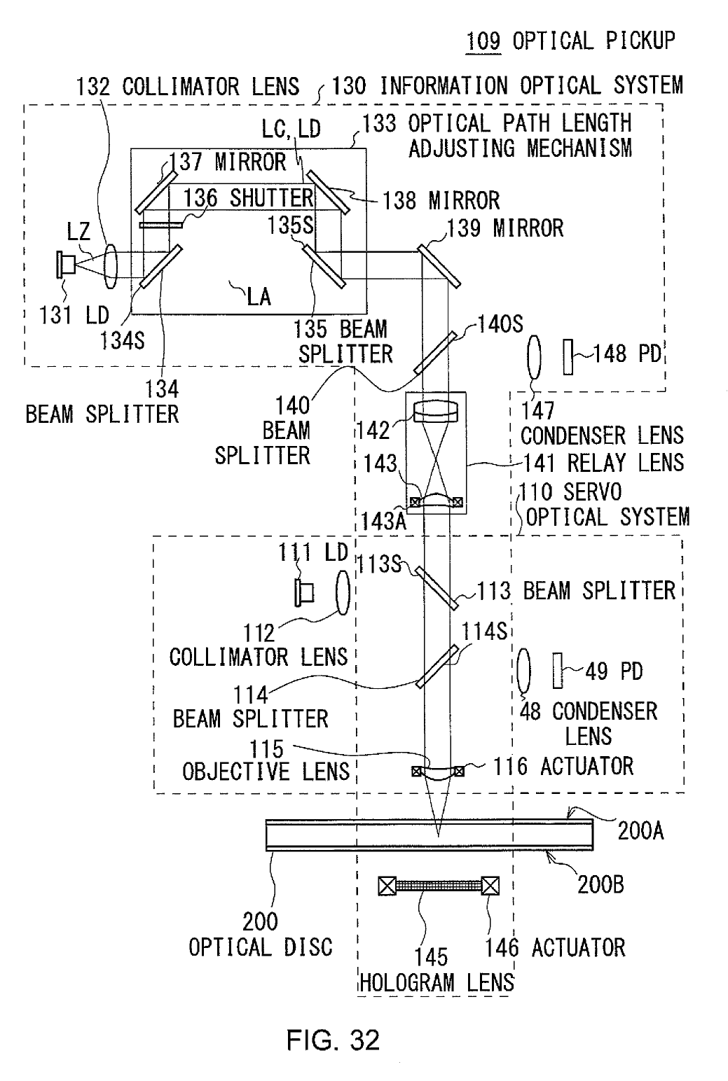

In FIG. 32, the laser diode 131 of the information optical system 130 can launch blue laser light of approximately 405 nm in wavelength. In fact, the laser diode 131 emits a light beam LZ of divergent light based on the control of the control unit 21 (FIG. 8) so that it is incident on a collimator lens 132. The collimator lens 132 converts the light beam LZ from divergent light to parallel light and makes it incident on an optical path length adjusting mechanism 133.

The optical path length adjusting mechanism 133 includes a beam splitter 134 which transmits or reflects a light beam in a predetermined ratio through/at its reflecting/transmitting surface 134S. Note that the ratio between the transmission and reflection of the beam splitter 134 is determined so that the light intensity of the diffracted light beam LB resulting from the reference light beam LA when irradiating the target mark position is the same as the light intensity of the recording light beam LC when irradiating the target mark position.

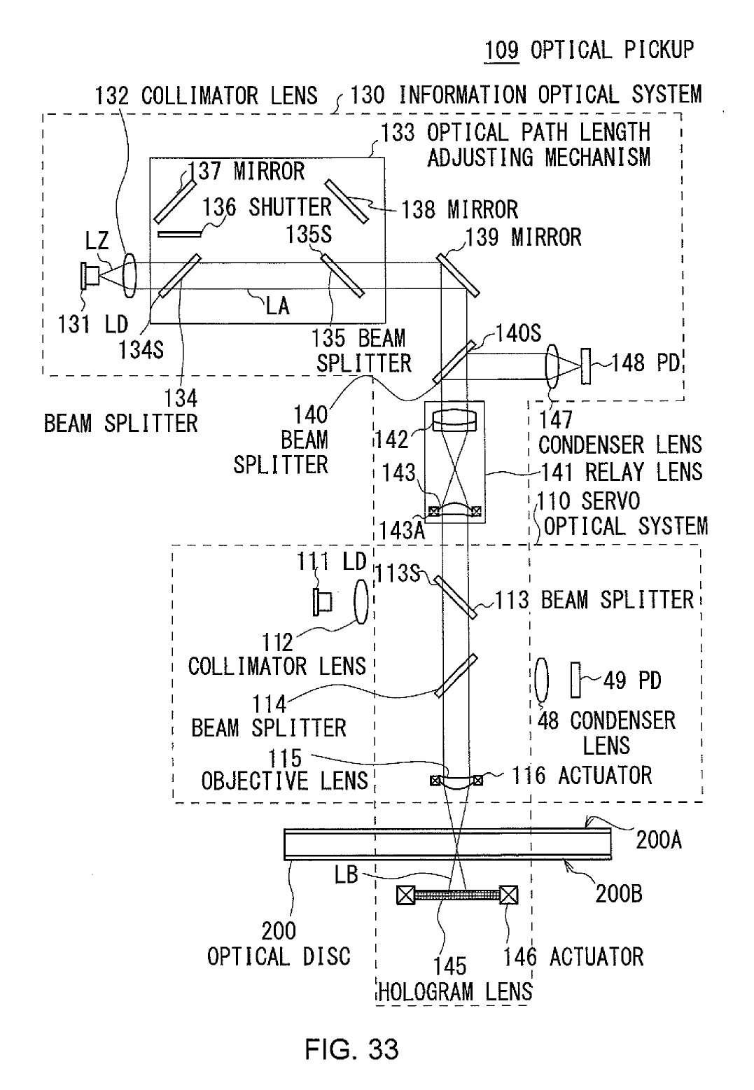

The beam splitter 134 then transmits a part of the light beam LZ so that it is incident on a beam splitter 135 as the recording light beam LA (see FIG. 33).

The beam splitter 135 transmits or reflects a light beam in a predetermined ratio through/at its reflecting/transmitting surface 135S. The beam splitter 135 then transmits a part of the reference light beam LA so that it is incident on a mirror 139.

In the meantime, the beam splitter 134 reflects a part of the incident light beam LZ, whereby the light beam LZ is deflected 90° in the traveling direction and is incident on a shutter 136 as the recording light beam LC.

The shutter 136 transmits or blocks a light beam under the control of the control unit 21 (FIG. 8). The shutter 136 transmits the recording light beam LC so that it is incident on a mirror 137.

The mirror 137 reflects the recording light beam LC, whereby the recording light beam LC is deflected 90° in the traveling direction and is incident on a mirror 138. The mirror 138 reflects the recording light beam LC, whereby the recording light beam LC is deflected 90° in the traveling direction and is incident on the beam splitter 135. The beam splitter 135 reflects a part of the recording light beam LC so that it is incident on the mirror 139.

That is, in the optical path length adjusting mechanism 133, the reference light beam LA is simply transmitted through the beam splitters 134 and 135 and is incident on the mirror 139. Meanwhile, the recording light beam LC is reflected by the beam splitter 134, and then by the mirrors 137 and 138 and the beam splitter 135, and is incident on the mirror 139.

Consequently, the optical path length adjusting mechanism 133 can extend the optical path length of the recording light beam LC, thereby making the optical path length of the recording light beam LC longer than that of the reference light beam LA.

The mirror 139 reflects the reference light beam LA and the recording light beam LC so that they are incident on a beam splitter 140. The beam splitter 140 transmits the reference light beam LA and the recording light beam LC so that they are incident on a relay lens 141.

The relay lens 141 converts the reference light beam LA and the recording light beam LC from parallel light into convergent light through a fixed lens 142. The reference light beam LA and the recording light beam LC converge and then become divergent light, which the relay lens 141 converts into convergent light again through a movable lens 143 and makes incident on the objective lens 115.

Here, the movable lens 143 is moved by an actuator 143A in the direction of the optical axes of the reference light beam LA and the recording light beam LC. In fact, the relay lens 141 can move the movable lens 143 with the actuator 143A based on the control of the control unit 21 (FIG. 8), thereby changing the states of convergence of the reference light beam LA and the recording light beam LC to be emitted from the movable lens 143.

The objective lens 115 collects the reference light beam LA and the recording light beam LC, and irradiates the first surface 200A of the optical disc 200 with these light beams. Here, as shown in FIG. 14B, the reference light beam LA and the recording light beam LC are transmitted through the substrate 202 and the servo layer 204, and are focused inside the stereoscopic mark recording layer 201.

The position of the focal point FA of the reference light beam LA and that of the focal point FC of the recording light beam LC are determined by the states of convergence of the light beams when emitted from the fixed lens 142 of the relay lens 141. The focal points FA and FC move toward the first surface 200A or toward the second surface 200B in the stereoscopic mark recording layer 201 according to the position of the movable lens 143.

The reference light beam LA and the recording light beam LC converge to the focal points FA and FC and then become divergent light. The resulting light beams LA and LC are transmitted through the stereoscopic mark recording layer 201 and the substrate 203 and emitted from the second surface 200B, and the hologram lens 145 is directly irradiated with these light beams.

As has been described with reference to FIG. 28, the hologram lens manufacturing apparatus 81 manufactures the hologram lens 145 by using the reference light beam L1 that is transmitted through the dummy disc 200X. In the optical pickup 109 (FIG. 29), the reference light beam LA is thus passed through the optical disc 200 so that the reference light beam LA can cause the same spherical aberration as that of the reference light beam L1.

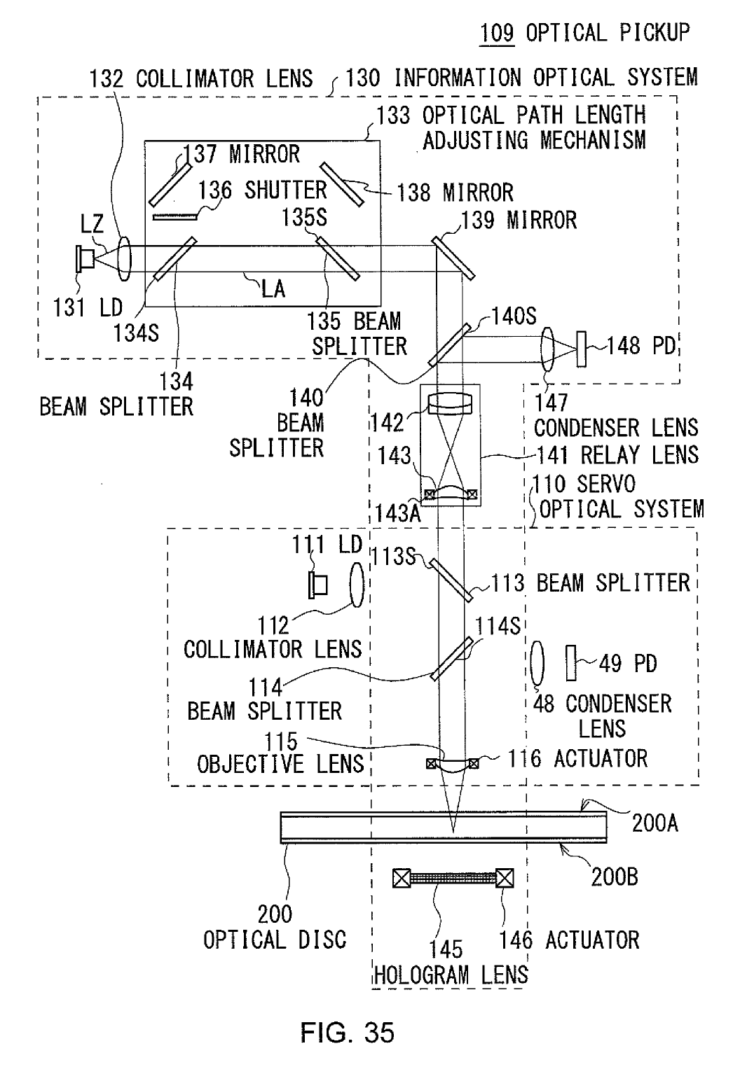

Consequently, as shown in FIGS. 34A and 34B, the hologram lens 145 is irradiated with the reference light beam LA and the recording light beam LC that have spherical waves corresponding to the irradiation distance DI from the focal points FA and FC of the reference light beam LA and the recording light beam LC to the opposed surface 145B.

The hologram lens 145 diffracts the reference light beam LA and the recording light beam LC with a hologram GM corresponding to the irradiation distance DI, thereby producing a diffracted light beam LB having a focal position corresponding to this irradiation distance DI, and irradiates the second surface 200B of the optical disc 200 with the diffracted light beam LB.

More specifically, as shown in FIG. 34A, when the hologram lens 145 is irradiated with a reference light beam LAa and a recording light beam LCa that have spherical waves corresponding to an irradiation distance DIa, it produces a diffracted light beam LBa from a hologram GMa corresponding to this irradiation distance DIa. As shown in FIG. 28A, this hologram GMa has been formed by the reference light beam L1a which has the same properties as those of the reference light beam LAa, and the irradiation light beam L2a which is projected to the same focal position.

The hologram lens 145 therefore produces the diffracted light beam LBa that has a focal point FBa at the same focal position (i.e., target mark position) as that of the reference light beam LAa.

Similarly, when the hologram lens 145 is irradiated with a reference light beam LAb and a recording light beam LCb that have spherical waves corresponding to an irradiation distance DIb, it produces a diffracted light beam LBb that has a focal point FBb at the same focal position as that of the reference light beam Lab.

Consequently, as shown in FIG. 14B, the diffracted light beam LB is transmitted through the substrate 203 to irradiate the target mark position in the stereoscopic mark recording layer 201.

Here, as shown in FIG. 31, the recording light beam LC is reflected by the mirrors 136 and 137 in the optical path length adjusting mechanism 133, and thus has a greater optical path length than that of the reference light beam LA.

This allows an adjustment in the information optical system 130 so that the optical path length of the recording light beam LC from the laser diode 131 to the focal point FC generally coincides with the optical path length from the laser diode 131 to the focal point FB of a light beam that is produced by diffracting the reference light beam LA of smaller optical path length in the hologram lens 145 (hereinafter, this light beam will be referred to as reference diffracted light beam LBa) out of the diffracted light beam LB.

Consequently, in the stereoscopic mark recording layer 201, the recording light beam LC and the reference diffracted light beam LBa interfere with each other to form a recording mark RM made of a hologram.

Note that the diffracted light beam LB includes a light beam that is produced by diffracting the recording light beam LC in the hologram lens 145 (hereinafter, this light beam will be referred to as recording diffracted light beam LBc). The recording diffracted light beam LBc has an optical path length greater than that of the recording light beam LC as much as the length of the optical path between when once transmitted through the optical disc 200 and when projected to inside the optical disc 200 again. This precludes the recording diffracted light beam LBc from interfering with the recording light beam LC, and from interfering with the reference light beam LA which has an optical path length even smaller than that of the recording light beam LC.

Since the reference light beam LA has an optical path length smaller than that of the recording light beam LC, the reference light beam LA will not interfere with the reference diffracted light beam LBa or the recording diffracted light beam LBc diffracted by the hologram lens 145.

Incidentally, like the objective lens 115, the hologram lens 145 is driven by an actuator 146 biaxially in focus directions and radial directions so that the focal point FB of the diffracted light beam LB follows the focal point FC of the recording light beam LC.

As described above, the information optical system 130 forms a recording mark RM by causing interference between the recording light beam LC that is projected from the objective lens 115 and the reference diffracted light LBa which results from the reference light beam LA that is once transmitted through the optical disc 200 and then projected to the hologram lens 145.

Subsequently, the diffracted light beam LB converges to the focal point FB and then becomes divergent light. The resulting diffracted light beam LB is transmitted through the stereoscopic mark recording layer 201 and the substrate 203, is emitted from the first surface 200A, and is incident on the objective lens 115.

Here, in the information optical system 130, the diffracted light beam LB is converged to some extent through the objective lens 115 before it is incident on the relay lens 141 through the beam splitters 114 and 113.

The relay lens 141 converts the diffracted light beam LB into generally parallel light, and makes it incident on the beam splitter 140. The beam splitter 140 reflects a part of the diffracted light beam LB at the reflecting/transmitting surface 140S so that it is incident on a condenser lens 147.

The condenser lens 147 converges the diffracted light beam LB with an additional astigmatic aberration, and irradiates a photodetector 148 with the diffracted light beam LB.

As described above, in the information recording processing, the information optical system 130 once separates the light beam LZ emitted from the laser diode 131 and creates a difference between the optical path lengths of the two light beams separated, i.e., the reference light beam LA and the recording light beam LC. The information optical system 130 then irradiates the optical disc 200 with the reference light beam LA and the recording light beam LC from the same objective lens 115 through the same optical path.

The information optical system 130 makes the reference light beam LA and the recording light beam LC simply pass through the optical disc 200, thereby irradiating the hologram lens 145 with these light beams, and irradiates the optical disc 200 with the diffracted light beam LB in response to the spherical waves.

The information optical system 130 thus causes interference between the recording light beam LC of greater optical path length and the reference diffracted light beam LBa which is produced by irradiating the hologram lens 145 with the reference light beam LA of small optical path length, thereby forming a recording mark RM.

### (3-2-3) Irradiation of Reproducing Light Beam in Information Reproduction Processing

Now, in information reproduction processing, as shown in FIG. 32, the optical pickup 109 emits a reproducing light beam LD of 405 nm from the laser diode 131 under the control of the control unit 21 (FIG. 8).

The information optical system 130 makes the reproducing light beam LD incident on the beam splitter 134 through the collimator lens 132. Here, the reproducing light beam LD reflected by the beam splitter 134 is blocked by the shutter 136 so as not to enter the subsequent optical path.

Like the recording light beam LC, the reproducing light beam LD transmitted through the beam splitter 134 is projected onto the optical disc 200 through the beam splitters 134 and 135, the mirror 139, the beam splitter 140, the relay lens 141, the beam splitters 113 and 114, and the objective lens 115.

Here, if the optical disc 200 has a recording mark RM recorded on the stereoscopic mark recording layer 201, the recording mark RM produces a reproduced diffracted light beam LBv due to its properties as a hologram when the focal point FC of the reproducing light beam LD is focused on this recording mark RM as described above.

According to the principles of a hologram, this reproduced diffracted light beam LBv reproduces the light beam with which the recording mark RM is irradiated along with the recording light beam LC at the time of recording, i.e., the diffracted light beam LB.

In the information optical system 130, the reproduced diffracted light beam LBv is thus converted into generally parallel light through the objective lens 115. The reproduced diffracted light beam LBv is then incident on the relay lens 141 through the beam splitters 114 and 113, is converted into parallel light through the movable lens 143 and the fixed lens 142 of the relay lens 141, and is incident on the beam splitter 140.

The beam splitter 140 reflects a part of the reproduced diffracted light beam LBv at the reflecting/transmitting surface 140S so that it is incident on the condenser lens 147. The condenser lens 147 collects the reproduced diffracted light beam LBv and irradiates the photodetector 148 with it.

On the other hand, if there is no recording mark RM recorded on the stereoscopic mark recording layer 201, the hologram lens 145 is irradiated with the reproducing light beam LD. Here, the information optical system 130 situates the hologram lens 145 in a position farther or closer than the distance DD from the optical disc 200 under the control of the control unit 21 (FIG. 8).

This precludes the hologram lens 145 from producing a reproduced diffracted light beam LBv since the spherical wave of the reference light beam L1 that is used when manufacturing the recorded holograms does not coincide with that of the reproducing light beam LD.

As described above, in the information reproduction processing, the information optical system 130 receives the reproduced diffracted light beam LBv that is incident on the objective lens 115 from the first surface 200A of the optical disc 200, and supplies the result of light reception to the signal processing unit 23.

### (3-3) Operation and Effect

With the foregoing configuration, the hologram lens manufacturing apparatus 81 irradiates the hologram recording element 145a with the reference light beam L1 of divergent light and the irradiation light beam L2, thereby recording holograms GM to manufacture the hologram lens 145.

This makes it possible for the hologram lens 145 to produce a diffracted light beam LB according to the reference light beam LA of generally the same spherical wave, with the difference between the spherical waves of reference light beams LA as an irradiation condition.

Moreover, the hologram lens manufacturing apparatus 81 irradiates the hologram lens 145 with a light beam that is once collected to focus, followed by divergence, as the reference light beam L1.

This makes it possible for the hologram lens 145 to produce the diffracted light beam LB according to the reference light beam LA that is once focused in the optical disc 200, followed by divergence. Consequently, the hologram lens 145 can use the light beam that is collected by the objective lens 93 and projected to the target mark position, simply as the reference light beam LA.

Furthermore, the hologram lens manufacturing apparatus 81 irradiates the hologram recording element 145a with the reference light beam L1 so that the focal point F2 of the irradiation light beam L2 and the focal point F1 of the reference light beam L1 generally coincide with each other.

This makes it possible for the hologram lens 145 to produce the diffracted light beam LB according to the light beam that focuses on the target mark position. The diffracted light beam LB can thus be produced according to the reference light beam LA that is projected to the same target mark position as the recording light beam LC is.

Consequently, the hologram lens 145 can adjust the focal position of the recording light beam LC and the focal position of the reference light beam LA at the same time, without the optical pickup 109 being provided with an additional mechanism for adjusting the focal position of the reference light beam LA. This can simplify the configuration of the optical pickup 109.

According to the foregoing configuration, the hologram lens manufacturing apparatus 81 irradiates the hologram recording element 145a with a plurality of pairs of reference light beams L1 and irradiation light beams L2 having respective different spherical waves, thereby fabricating a hologram lens 145 containing a plurality of holograms GM. The hologram lens 145 can thus produce diffracted light beams LB having different focal positions according to the spherical waves of reference light beams LA.

### (3-4) Other Embodiments

The foregoing third embodiment has dealt with the case where the focal points F1 and F2 of the reference light beam L1 and the irradiation light beam L2 are made to generally coincide with each other. The present invention is not limited thereto, however, and the focal points F1 and F2 may differ from each other.

The foregoing third embodiment has also dealt with the case where the position of the focal point F1 of the reference light beam L1 is adjusted by the relay lens. However, the present invention is not limited thereto. For example, the objective lens may be moved. As a means for displacing the focal point F1 of the reference light beam L1, however, it is preferred to use the same configuration as that for displacing the focal point FA of the reference light beam LA in the optical pickup 109 which uses the hologram lens 145.

The foregoing third embodiment has also dealt with the case where the focal position of the reference light beam L1 is displaced to change the spherical wave of the reference light beam L1. However, the present invention is not limited thereto. For example, a mechanism for changing a spherical wave by using a diffractive element or the like may be provided to change the spherical wave of the reference light beam L1.

The foregoing third embodiment has dealt with the case where the laser diode 83 having a short coherence length is used so that the recording light beam LC and the diffracted light beam LBa interfere with each other to form a recording mark RM. However, the present invention is not limited thereto. For example, a laser light source having a long coherence length may be used so that the reference light beam LA and the diffracted light beam LB interfere with each other to form a recording mark RM. This eliminates the need for the recording light beam LC, and the light beam L0 can simply be used as the reference light beam LA.

The foregoing third embodiment has also dealt with the case where the optical pickup 109 has the optical path length adjusting mechanism 133 that is composed of the beam splitters 134 and 135 and the mirrors 137 and 138. However, the present invention is not limited thereto. For example, the mirror 137 may be replaced with the same configuration as that of the optical path length adjusting mechanism 86 of the hologram lens manufacturing apparatus 81. The recording light beam LC can thereby be adjusted to generally the same optical path length as that of the reference light beam LA according to the target mark position.

The foregoing third embodiment has also dealt with the case where the hologram lens 145 is situated farther or closer than the distance DD while the optical pickup 109 is reproducing information. However, the present invention is not limited thereto. For example, a shutter may be arranged between the hologram lens 145 and the optical disc 200 so as to block the reference light beam LA and the recording light beam LC during information reproduction.

The configurations of the hologram lens manufacturing apparatuses 1, 1X, and 81 according to the foregoing first to third embodiments may be combined as appropriate. The configurations of the optical pickups 29, 39, and 109 described above may also be combined as appropriate.

The hologram lens manufacturing apparatus, the hologram lens, the method of manufacturing a hologram lens, the information recording apparatus, and the information reproducing apparatus according to the embodiment of the present invention may be applied to various types of electronic equipment having an optical disc apparatus, for example.

It should be understood by those skilled in the art that various modifications, combinations, sub-combinations and alterations may occur depending on design requirements and other factors insofar as they are within the scope of the appended claims or the equivalents thereof.

What is claimed is:

1. A hologram lens manufacturing apparatus comprising:
a separation unit that separates a light beam emitted from a light source into a reference light beam and an irradiation light beam;
an irradiation light irradiating unit that collects the irradiation light beam so as to have a focal point at a predetermined focal position, and irradiates a hologram recording element located on a way to the focal point with the irradiation light beam; and
a reference light irradiating unit that irradiates the hologram recording element with the reference light beam under a predetermined irradiation condition to record an interference pattern occurring between the irradiation light beam and the reference light beam as a hologram.

2. The hologram lens manufacturing apparatus according to claim 1, comprising
a control unit that controls the irradiation light irradiating unit and the reference light irradiating unit so as to irradiate the hologram recording element with the irradiation light beam and the reference light beam of different focal positions and different irradiation conditions to form a plurality of holograms on the hologram recording element in a superimposed fashion.

3. The hologram lens manufacturing apparatus according to claim 2, wherein
the irradiation light irradiating unit adds an aberration to the irradiation light beam.

4. The hologram lens manufacturing apparatus according to claim 3, wherein
the irradiation light irradiating unit adds different amounts of aberration to irradiation light beams having respective different focal positions.

5. The hologram lens manufacturing apparatus according to claim 4, wherein
the aberration has an opposite sign to and generally a same amount as those of a spherical aberration that is assumed to occur when an object to be irradiated is irradiated with the irradiation light beam.

6. The hologram lens manufacturing apparatus according to claim 5, wherein
the object to be irradiated is an optical information recording medium for recording information as a recording mark.

7. The hologram lens manufacturing apparatus according to claim 2, wherein:
the reference light beam is composed of parallel light; and
the control unit changes the irradiation condition by changing an angle of incidence of the reference light beam on the hologram recording element.

8. The hologram lens manufacturing apparatus according to claim 7, wherein
the reference light irradiating unit irradiates the hologram recording element with the reference light beam at an incident surface thereof where the irradiation light beam is incident on.

9. The hologram lens manufacturing apparatus according to claim 8, wherein
the irradiation light irradiating unit includes:
a plurality of objective lenses each designed to have a near optimum spherical aberration according to the focal position; and
a switching unit that switches an objective lens to collect the irradiation light beam.

10. The hologram lens manufacturing apparatus according to claim 8, wherein
the irradiation light irradiating unit includes:
a relay lens that changes a state of convergence of the irradiation light beam, the relay lens having a movable lens capable of being driven in a direction of an optical axis of the irradiation light beam and a fixed lens in combination; and
an objective lens designed to give a near optimum spherical aberration to the irradiation light beam according to a focal position determined by the state of convergence changed.

11. The hologram lens manufacturing apparatus according to claim 6, wherein
the reference light irradiating unit is composed of a rotating mirror for reflecting the reference light beam, a reflecting surface of the rotating mirror being changeable in angle with respect to an optical axis of the reference light beam.

12. The hologram lens manufacturing apparatus according to claim 6, wherein
the reference light irradiating unit irradiates the hologram recording element with the reference light beam at a backside opposite from an incident surface thereof where the irradiation light beam is incident on.

13. The hologram lens manufacturing apparatus according to claim 1, wherein
the reference light beam is composed of divergent light or convergent light, whose spherical wave is changed to change the irradiation condition.

14. The hologram lens manufacturing apparatus according to claim 13, wherein
the reference light irradiating unit projects the reference light beam so that the focal point of the irradiation light beam and the focal point of the reference light beam generally coincide with each other.

15. A hologram lens comprising
a single hologram recorded by irradiation with a single irradiation light beam of convergent light focusing on a single focal position and a single reference light beam projected under a single irradiation condition.

16. The hologram lens according to claim 15, comprising
one or more other holograms recorded by irradiation with a pair or a plurality of pairs of different irradiation light beams and different reference light beams, the pair(s) each including a different irradiation light beam of convergent light focusing on a different focal position other than the single focal position and a different reference light beam projected under a different irradiation condition other than the single irradiation condition.

17. A method of manufacturing a hologram lens, comprising:
a single hologram recording step of collecting an irradiation light beam so as to have a focal point at a single focal position, irradiating a hologram recording element located on a way to the focal position with the irradiation light beam, and irradiating the hologram recording element with a reference light beam under a single irradiation condition to record a single hologram, the reference light beam and the irradiation light beam being emitted from a single light source before separation.

18. An information recording apparatus comprising:
a hologram lens that is opposed to an optical information recording medium and has a hologram recorded by irradiation with an irradiation light beam of convergent light having a focal point at a predetermined focal position and a reference light beam projected under a predetermined irradiation condition;
a light source that emits a light beam having a same wavelength as that of the reference light beam; and
an irradiating unit that irradiates the hologram lens with the light beam under the predetermined irradiation condition to make the hologram lens produce a diffracted light beam having a focal point at the focal position and irradiate the optical information recording medium with the diffracted light beam.

19. An information reproducing apparatus comprising:
a hologram lens that is opposed to an optical information recording medium and has a hologram recorded by irradiation with an irradiation light beam of convergent light having a focal point at a predetermined focal position and a reference light beam projected under a predetermined irradiation condition;
a light source that emits a light beam having a same wavelength as that of the reference light beam;
an irradiating unit that irradiates the hologram lens with the light beam under the predetermined irradiation condition to make the hologram lens produce a diffracted light beam having a focal point at the focal position and irradiate the optical information recording medium with the diffracted light beam; and
a light detection unit that detects a presence or absence of light modulation on the diffracted light beam corresponding to the presence or absence of a recording mark near the focal point of the diffracted light beam.
